(19) United States
(12) Patent Application Publication
(10) Pub. No.: US 2022/0303578 A1
(43) Pub. Date: Sep. 22, 2022

(54) IMAGE PROCESSING APPARATUS AND METHOD

(71) Applicant: SONY GROUP CORPORATION, Tokyo (JP)

(72) Inventors: Satoru KUMA, Tokyo (JP); Ohji NAKAGAMI, Tokyo (JP); Koji YANO, Tokyo (JP); Tsuyoshi KATO, Kanagawa (JP); Hiroyuki YASUDA, Saitama (JP)

(73) Assignee: SONY GROUP CORPORATION, Tokyo (JP)

(21) Appl. No.: 17/770,179

(22) PCT Filed: Oct. 30, 2020
(86) PCT No.: PCT/JP2020/040800

§ 371 Date: Apr. 19, 2022

(30) Foreign Application Priority Data
Nov. 13, 2019 (JP) 2019-205240

(51) Int. Cl. H04N 19/597

(52) U.S. Cl. CPC H04N 19/597

(57) ABSTRACT

There is provided an image processing apparatus and a method designed to be capable of reducing degradation of the subjective quality of a point cloud. Encoded data of a frame image in which a projection image of a point cloud representing a three-dimensional object as a set of points on a two-dimensional plane is placed is decoded, the frame image obtained by decoding the encoded data is unpacked to extract the projection image, and the respective points included in the extracted projection image are arranged in a three-dimensional space. When the coordinates of a point are not integer values in a basic coordinate system that is a predetermined coordinate system of the three-dimensional space, the point is moved in a direction perpendicular to the two-dimensional plane so that the coordinates of the point become integer values. Thus, the point cloud is reconstructed. The present disclosure can be applied to an image processing apparatus, an electronic apparatus, an image processing method, a program, or the like, for example.

### TECHNICAL FIELD

The present disclosure relates to image processing apparatuses and methods, and more particularly, to an image processing apparatus and a method designed to be capable of reducing degradation of the subjective quality of a point cloud.

### BACKGROUND ART

Encoding and decoding of point cloud data expressing a three-dimensional object as a set of points has been standardized by Moving Picture Experts Group (MPEG) (see Non-Patent Document 1, for example).

Also, a method has been suggested for projecting the positional information and the attribute information about a point cloud onto a two-dimensional plane in each small region, arranging images (patches) projected onto the two-dimensional plane in a frame image, and encoding the frame image by an encoding method for two-dimensional images (hereinafter, this method will also be referred to as the video-based approach) (see Non-Patent Documents 2 to 4, for example).

Further, in the video-based approach, a tool that adds 45 degrees to the six orthogonal directions as the projection directions of points has been adopted (see Non-Patent Document 5, for example).

### CITATION LIST

### Non-Patent Documents

Non-Patent Document 1: “Information technology—MPEG-I (Coded Representation of Immersive Media)—Part 9: Geometry-based Point Cloud Compression”, ISO/IEC 23090-9: 2019(E)
Non-Patent Document 2: Tim Golla and Reinhard Klein, “Real-time Point Cloud Compression”, IEEE, 2015
Non-Patent Document 3: K. Mammou, “Video-based and Hierarchical Approaches Point Cloud Compression”, MPEG m41649, October 2017
Non-Patent Document 4: K. Mammou, “PCC Test Model Category 2 v0”, N17248 MPEG output document, October 2017
Non-Patent Document 5: Satoru Kuma and Ohji Nakagami, “PCC TMC2 with additional projection plane”, ISO/IEC JTC1/SC29/WG11 MPEG2018/m43494, July 2018, Ljubljana, SI

### SUMMARY OF THE INVENTION

### Problems to be Solved by the Invention

However, how an actual depth value strains depends on the projection direction. Therefore, in a case where the decimal values of coordinates are simply rounded down or up so as to adjust reconfigured point positions with decimal precision to integer positions, there is a possibility that the subjective quality of the reconstructed point cloud will be degraded.

The present disclosure is made in view of such circumstances, and is to reduce degradation of the subjective quality of a point cloud.

### Solutions to Problems

An image processing apparatus according to one aspect of the present technology is an image processing apparatus that includes: a decoding unit that decodes encoded data of a frame image in which a projection image of a point cloud representing a three-dimensional object as a set of points on a two-dimensional plane is placed; an unpacking unit that unpacks the frame image obtained by the decoding unit decoding the encoded data, and extracts the projection image; and a reconstruction unit that reconstructs the point cloud by arranging the respective points included in the projection image extracted by the unpacking unit in a three-dimensional space. When the coordinates of a point are not integer values in a basic coordinate system that is a predetermined coordinate system of the three-dimensional space, the reconstruction unit moves the point in a direction perpendicular to the two-dimensional plane so as to turn the coordinates of the point into integer values.

An image processing method according to one aspect of the present technology is an image processing method that includes: decoding encoded data of a frame image in which a projection image of a point cloud representing a three-dimensional object as a set of points on a two-dimensional plane is placed; unpacking the frame image obtained by decoding the encoded data, and extracting the projection image; and reconstructing the point cloud by arranging the respective points included in the extracted projection image in a three-dimensional space, and, when the coordinates of a point are not integer values in a basic coordinate system that is a predetermined coordinate system of the three-dimensional space, moving the point in a direction perpendicular to the two-dimensional plane so as to turn the coordinates of the point into integer values.

In the image processing apparatus and method according to one aspect of the present technology, encoded data of a frame image in which a projection image of a point cloud representing a three-dimensional object as a set of points on a two-dimensional plane is placed is decoded, the frame image obtained by decoding the encoded data is unpacked to extract the projection image, and the respective points included in the extracted projection image are arranged in a three-dimensional space. When the coordinates of a point are not integer values in the basic coordinate system that is the predetermined coordinate system of the three-dimensional space, the point is moved in a direction perpendicular to the two-dimensional plane so that the coordinates of the point become integer values. Thus, the point cloud is reconstructed.

### BRIEF DESCRIPTION OF DRAWINGS

FIG. 1 is a diagram for explaining an example state of point cloud reconstruction.

FIG. 2 is a diagram for explaining an example state of point cloud reconstruction.

FIG. 3 is a diagram for explaining an example state of point cloud reconstruction.

FIG. 4 is a diagram for explaining an example state of point cloud reconstruction.

FIG. 5 is a diagram for explaining an example of degradation of subjective quality due to compression strain.

FIG. 6 is a table for explaining point cloud reconstruction methods.

FIG. 7 is a diagram for explaining Method 1.

FIG. 8 is a diagram for explaining Method 1.

FIG. 9 is a diagram for explaining Method 1.

FIG. 10 is a diagram for explaining Method 1.

FIG. 11 is a diagram for explaining Method 1.

FIG. 12 is a diagram for explaining Method 1.

FIG. 13 is a diagram for explaining Method 2.

FIG. 14 is a diagram for explaining Method 2.

FIG. 15 is a diagram for explaining Method 2.

FIG. 16 is a diagram for explaining Method 2.

FIG. 17 is a diagram for explaining Method 2.

FIG. 18 is a block diagram showing a typical example configuration of an encoding device.

FIG. 19 is a flowchart for explaining an example flow in an encoding process.

FIG. 20 is a block diagram showing a typical example configuration of a decoding device.

FIG. 21 is a block diagram showing a typical example configuration of a 3D reconstruction unit.

FIG. 22 is a flowchart for explaining an example flow in a decoding process.

FIG. 23 is a flowchart for explaining an example flow in a point cloud reconstruction process.

FIG. 24 is a flowchart for explaining an example flow in a point cloud reconstruction process.

FIG. 25 is a block diagram showing a typical example configuration of a computer.

### MODES FOR CARRYING OUT THE INVENTION

The following is a description of modes for carrying out the present disclosure (these modes will be hereinafter referred to as embodiments). Note that explanation will be made in the following order.

1. Point cloud reconstruction

2. First Embodiment

3. Notes

### 1. Point Cloud Reconstruction

<Documents and the Like that Support Technical Contents and Terms>

The scope disclosed in the present technology includes not only the contents disclosed in the embodiments, but also the contents disclosed in the following non-patent documents that were known at the time of filing, the contents of other documents referred to in the non-patent documents listed below, and the like.
Non-Patent Document 1: (mentioned above)
Non-Patent Document 2: (mentioned above)
Non-Patent Document 3: (mentioned above)
Non-Patent Document 4: (mentioned above)
Non-Patent Document 5: (mentioned above)

That is, the contents described in the above non-patent documents, the contents of other documents referred to in the above non-patent documents, and the like are also grounds for determining the support requirements.

<Point Cloud>

There has been 3D data such as a point cloud representing a three-dimensional structure with positional information, attribute information, and the like about points.

For example, in the case of a point cloud, a three-dimensional structure (a three-dimensional object) is expressed as a set of a large number of points. The data of a point cloud (also referred to as point cloud data) includes positional information (also referred to as geometry data) and attribute information (also referred to as attribute data) about the respective points. The attribute data can include any information. For example, color information, reflectance information, normal information, and the like regarding the respective points may be included in the attribute data. As described above, the data structure of point cloud data is relatively simple, and any desired three-dimensional structure can be expressed with a sufficiently high accuracy with the use of a sufficiently large number of points.

<Quantization of Positional Information Using Voxels>

Since the data amount of such point cloud data is relatively large, an encoding method using voxels has been suggested to reduce the data amount by encoding and the like. A voxel is a three-dimensional region for quantizing geometry data (positional information).

That is, a three-dimensional region containing a point cloud (such a region is also called a bounding box) is divided into small three-dimensional regions called voxels, and each voxel indicates whether or not points are contained therein. With this arrangement, the position of each point is quantized in voxel units. Accordingly, point cloud data is transformed into such data of voxels (also referred to as voxel data), so that an increase in the amount of information can be prevented (typically, the amount of information can be reduced).

<Outline of the Video-Based Approach>

In the video-based approach, the geometry data and the attribute data of such a point cloud are projected onto a two-dimensional plane for each small region. An image obtained by projecting the geometry data and the attribute data onto a two-dimensional plane is also called a projection image. Also, the projection image in each small region is called a patch. For example, in the projection image (patches) of the geometry data, the position information about a point is expressed as positional information (depth value (Depth)) about a direction perpendicular to the projection plane (depth direction). Non-Patent Document 5 discloses a method by which 45 degrees is added to six orthogonal directions as the point projection directions.

The respective patches generated in this manner are then arranged in a frame image. A frame image in which patches of geometry data are arranged is also called a geometry video frame. A frame image in which patches of attribute data are arranged is also called a color video frame. For example, each pixel value of the geometry video frame indicates the depth value mentioned above.

Each video frame generated in the above manner is then encoded by an encoding method for two-dimensional images, such as Advanced Video Coding (AVC) or High Efficiency Video Coding (HEVC), for example.

<Occupancy Map>

Further, in the case of such a video-based approach, an occupancy map can also be used. An occupancy map is map information indicating the presence or absence of a projection image (a patch) in each N×N pixels of a geometry video frame. For example, the occupancy map shows the value “1” in a region (N×N pixels) in which a patch exists, and shows the value “0” in a region (N×N pixels) in which any patch does not exist, in the geometry video frame.

Such an occupancy map is encoded as data separate from the geometry video frame and the color video frame, and is transmitted to the decoding side. As a decoder can recognize whether or not the region is a region in which a patch exists by referring to this occupancy map, the influence of noise and the like caused by encoding/decoding can be reduced, and the 3D data can be restored more accurately. For example, even if the depth value changes due to encoding/decoding, the decoder can ignore the depth value of each region in which no patches are present (does not process the depth value as the positional information about the 3D data), by referring to the occupancy map.

<Compression Strain>

However, in the case of this video-based approach, encoding/decoding of a video frame is performed in an irreversible manner, and therefore, a pixel value might change before encoding and after decoding. That is, the position of a point might change in the projection direction (compression strain might occur). Therefore, there is a possibility of degradation of the subjective quality of the point cloud reconstructed by decoding the encoded data generated by the video-based approach (which is the subjective image quality of the display image obtained by projecting the point cloud onto a two-dimensional plane).

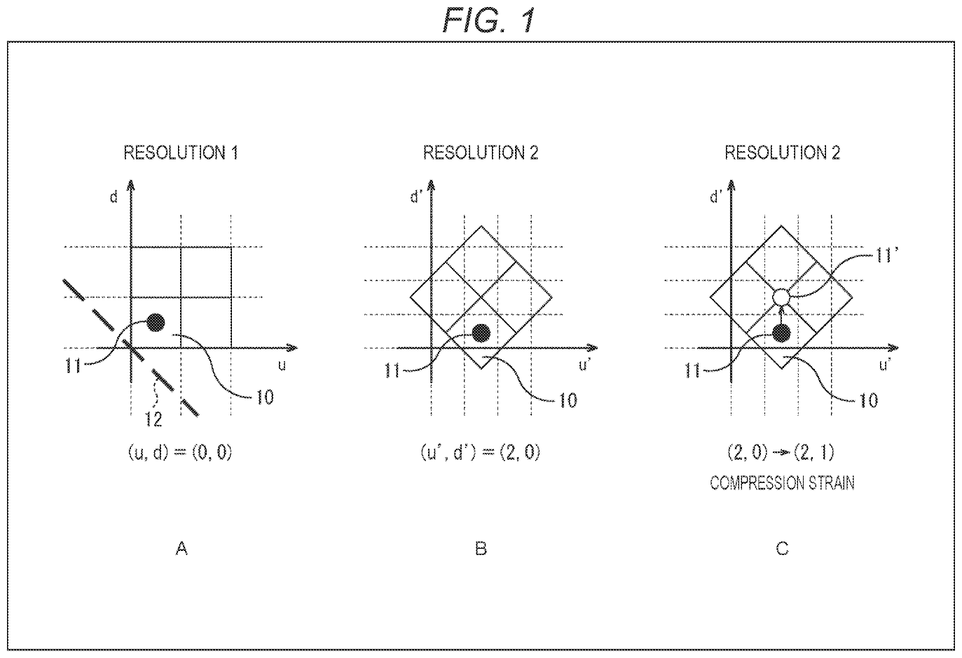

For example, a point 11 of a voxel 10 is projected onto a projection plane 12 that is a predetermined two-dimensional plane, as shown in A of FIG. 1. Note that, in the present specification, an example case that is actually caused in a three-dimensional space is described with the use of a two-dimensional plane, for ease of explanation. Here, the coordinate system of a three-dimensional space having coordinate axes along the respective sides of a voxel (the voxel 10 in the example case in FIG. 1) is called the basic coordinate system. A d-axis and a u-axis are coordinate axes perpendicular to each other in the basic coordinate system. The coordinates (u, d) of the point 11 in the basic coordinate system are defined as (0, 0). The projection plane 12 then passes through the lower left corner (the origin of the basic coordinate system) of the voxel 10 in the drawing, and has an angle of 45 degrees with respect to the u-axis and the d-axis. That is, the projection direction of the point 11 is the direction toward the lower left (45 degrees) in the drawing.

When this basic coordinate system is replaced with a coordinate system having coordinate axes perpendicular to the projection plane (this coordinate system is called the projection coordinate system), the coordinates are as shown in B of FIG. 1, for example. In this case, the d′-axis is a coordinate system perpendicular to the projection plane 12, and the u′-axis is a coordinate system parallel to the projection plane 12. The coordinates (u′, d′) of the point 11 in this projection coordinate system are (2, 0).

As encoding/decoding is performed by the video-based approach, the position of the point 11 moves along the d′-axis (in a direction perpendicular to the projection plane 12) due to compression strain, as in C of FIG. 1, for example. The point 11 after this movement is defined as a point 11′. As shown in C of FIG. 1, the coordinates (u′, d′) of the point 11′ are (2, 1).

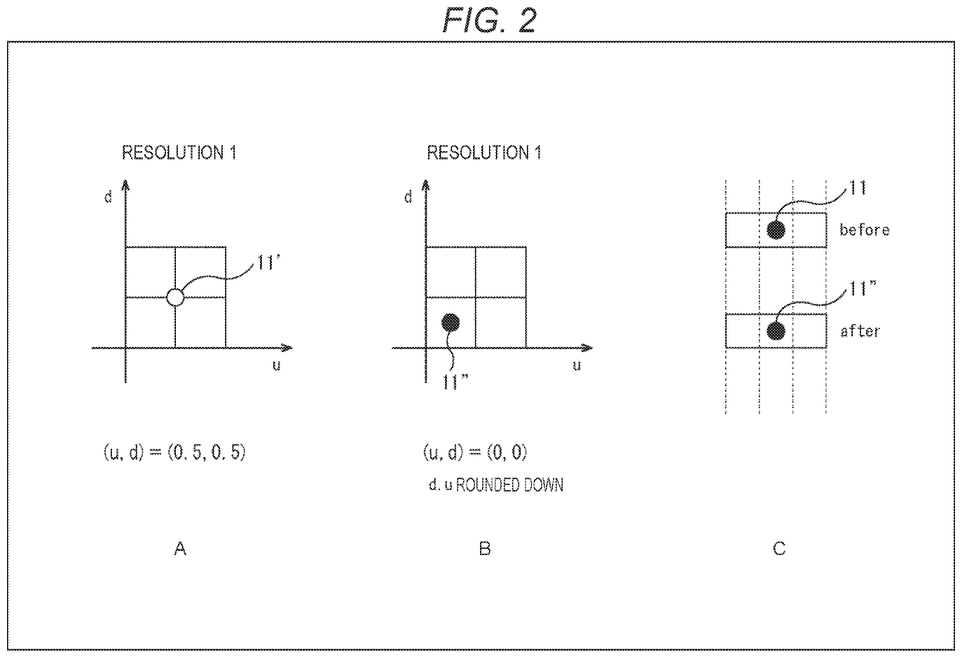

The coordinates of this point 11′ are (0.5, 0.5) in the basic coordinate system, as shown in A of FIG. 2. By the currently adopted method, the coordinates with decimal precision are rounded down to integer precision, as the decimal fractions are rounded off. Therefore, the coordinates (u, d) of the point 11′ in the basic coordinate system are rounded down to (0, 0), as shown in B of FIG. 2.

In this case, as indicated by “before” and “after” in C of FIG. 2, the position of the point 11 and the position of the point 11′ as viewed from the projection plane 12 are the same. That is, the position of the point 11 in the horizontal direction with respect to the projection plane does not change before and after encoding/decoding.

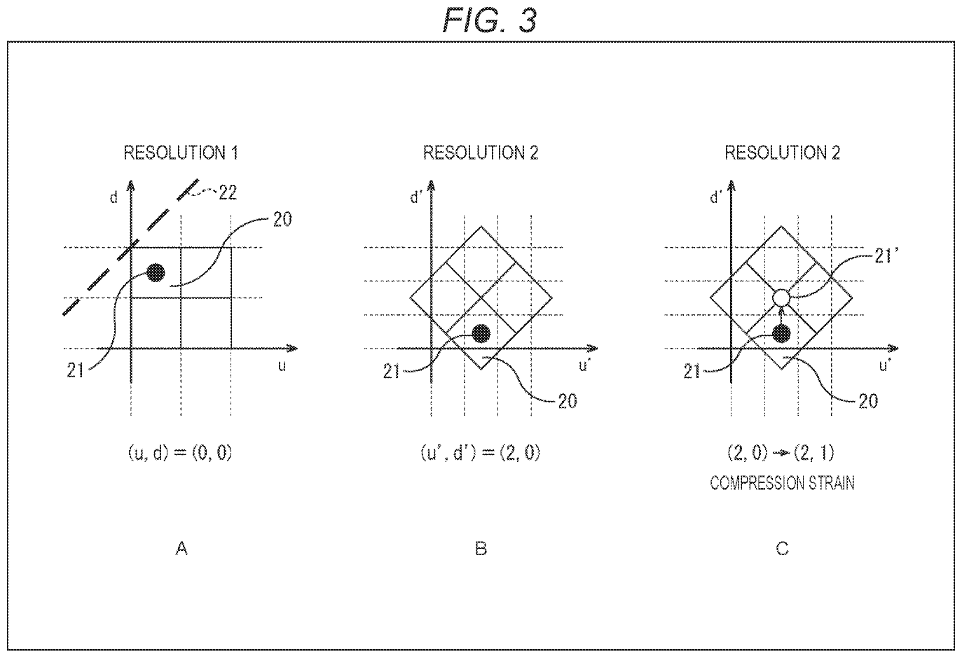

For example, a point 21 of a voxel 20 is projected onto a projection plane 22 that is a predetermined two-dimensional plane, as shown in A of FIG. 3. The coordinates (u, d) of the point 21 in the basic coordinate system are defined as (0, 1). The projection plane 22 then passes through the upper left corner of the voxel 20 in the drawing, and has an angle of 45 degrees with respect to the u-axis and the d-axis. That is, the projection direction of the point 21 is a direction toward the upper left (45 degrees) in the drawing.

When this basic coordinate system is replaced with a projection coordinate system, the coordinates are as shown in B of FIG. 3, for example. In this case, the d′-axis is a coordinate system perpendicular to the projection plane 22, and the u′-axis is a coordinate system parallel to the projection plane 22. The coordinates (u′, d′) of the point 21 in this projection coordinate system are (2, 0).

As encoding/decoding is performed by the video-based approach, the position of the point 21 moves along the d′-axis (in a direction perpendicular to the projection plane 22) due to compression strain, as in C of FIG. 3, for example. The point 21 after this movement is defined as a point 21′. As shown in C of FIG. 3, the coordinates (u′, d′) of the point 31′ are (2, 1).

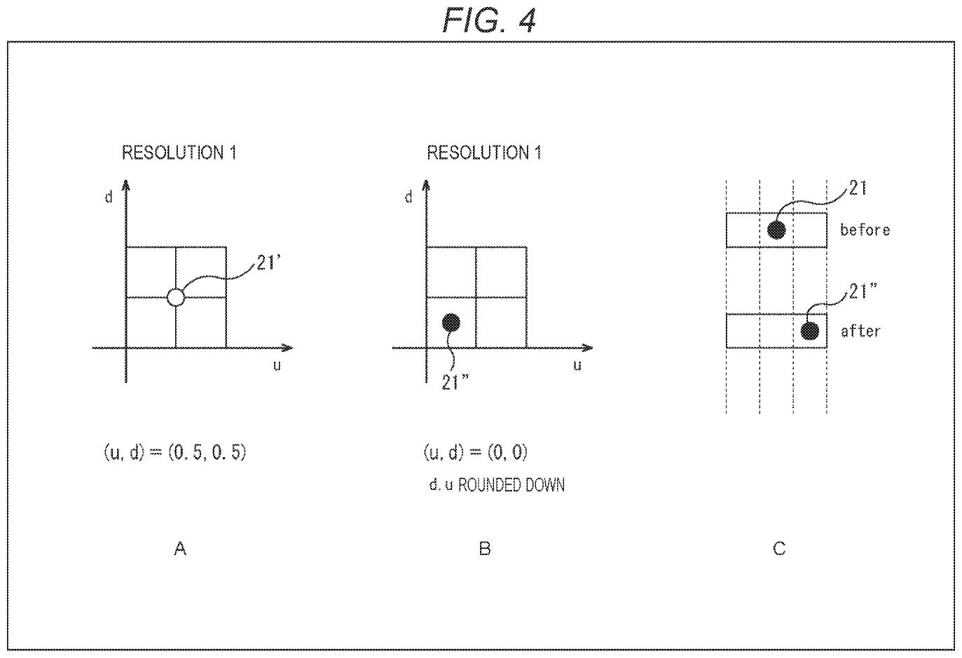

The coordinates of this point 21′ are (0.5, 0.5) in the basic coordinate system, as shown in A of FIG. 4. By the currently adopted method, the coordinates with decimal precision are rounded down to integer precision, as the decimal fractions are rounded off. Therefore, the coordinates (u, d) of the point 21′ in the basic coordinate system are rounded down to (0, 0), as shown in B of FIG. 4.

In this case, as indicated by “before” and “after” in C of FIG. 4, the position of the point 21 and the position of the point 21′ as viewed from the projection plane 22 differ from each other. That is, the position of the point 21 in the horizontal direction with respect to the projection plane moves in the horizontal direction before and after encoding/decoding.

<Quality Degradation Due to Compression Strain>

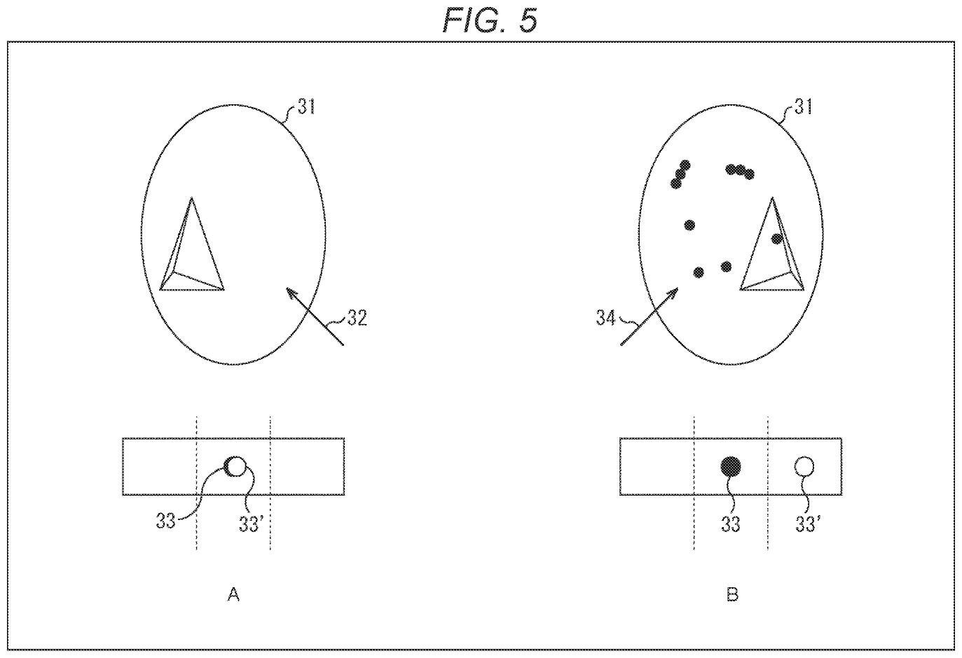

For example, as shown in A of FIG. 5, a point cloud 31 is a point cloud reconstructed through encoding and decoding by the video-based approach, and an arrow 32 indicates the line-of-sight direction when the point cloud 31 is viewed from the projection plane (that is, the line-of-sight direction is a direction perpendicular to the projection plane). Further, a point 33 is a predetermined point of the point cloud 31 before encoding/decoding, and a point 33′ is the point 33 after encoding/decoding.

The lower side in A of FIG. 5 shows the positions of the point 33 and the point 33 as viewed from the projection plane. In this case, the positions of the point 33 and the point 33 as viewed from the projection plane, which are the positions of the point 33 and the point 33 in the horizontal direction with respect to the projection plane, are the same as each other.

Like the point 33, when the positions of the respective points of the point cloud 31 as viewed from the projection plane are the same before and after encoding/decoding, the images of the point cloud 31 as viewed from the arrow 32 are substantially similar before and after encoding/decoding. That is, when the points of a point cloud do not move in the horizontal direction with respect to the projection plane because of rounding of the coordinates as above, degradation of the subjective quality of the point cloud 31 is reduced.

In B of FIG. 5, an arrow 34 indicates the line-of-sight direction when the point cloud 31 is viewed from the projection plane (that is, the line-of-sight direction is a direction perpendicular to the projection plane). As shown at the lower side in B of FIG. 5, the positions of the point 33 and the point 33 in this case as viewed from the projection plane, which are the positions of the point 33 and the point 33 in the horizontal direction with respect to the projection plane, differ from each other.

Like this point 33, when the position of each point of the point cloud 31 as viewed from the projection plane changes (or moves in the horizontal direction with respect to the projection plane) due to rounding of the coordinates, there is a possibility that a hole will be formed in the point cloud 31 when the point cloud 31 after encoding/decoding is viewed from the arrow 34. Therefore, there is a possibility that the subjective image quality of the image will be degraded when the point cloud 31 is viewed in the direction of the arrow 34. That is, there is a possibility that the subjective quality of the point cloud 31 will be degraded due to rounding of the coordinates.

<Turning Coordinates into Integers>

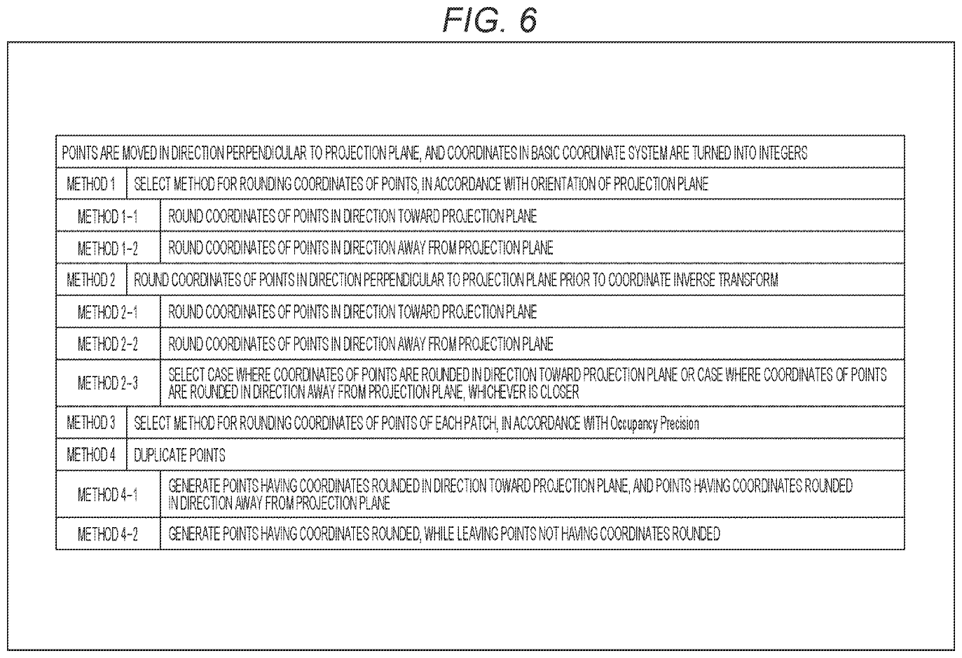

Therefore, as shown in the top row in the table shown in FIG. 6, the coordinates in the basic coordinate system are turned into integers by moving the points in a direction perpendicular to the projection plane.

For example, encoded data of a frame image in which a projection image of a point cloud representing a three-dimensional object as a set of points on a two-dimensional plane is placed is decoded, the frame image obtained by decoding the encoded data is unpacked to extract the projection image, and the respective points included in the extracted projection image are arranged in a three-dimensional space. When the coordinates of a point are not integer values in the basic coordinate system that is the predetermined coordinate system of the three-dimensional space, the point is moved in a direction perpendicular to the two-dimensional plane so that the coordinates of the point become integer values. Thus, the point cloud is reconstructed.

For example, an information processing apparatus includes: a decoding unit that decodes encoded data of a frame image in which a projection image of a point cloud representing a three-dimensional object as a set of points on a two-dimensional plane is placed; an unpacking unit that unpacks the frame image obtained by the decoding unit decoding the encoded data, and extracts the projection image; and a reconstruction unit that reconstructs the point cloud by arranging the respective points included in the projection image extracted by the unpacking unit in a three-dimensional space. When the coordinates of a point are not integer values in the basic coordinate system that is the predetermined coordinate system of the three-dimensional space, the reconstruction unit moves the point in a direction perpendicular to the two-dimensional plane so that the coordinates of the point become integer values.

In this manner, movement of points in the horizontal direction with respect to the projection plane due to rounding of the coordinates can be reduced, and thus, degradation of the subjective quality of the point cloud can be reduced.

<Rounding Process in the Basic Coordinate System>

At that stage, a method for rounding the coordinates of a point may be selected in accordance with the orientation of the projection plane, like Method 1 shown in the second row from the top in the table in FIG. 6. For example, the coordinates of the basic coordinate system of a point may be updated, to move the point. That is, in the basic coordinate system, a point may be moved in a direction perpendicular to the projection plane so that the coordinates of the point become integer values.

Also, for each coordinate in the basic coordinate system of a point, the decimal value may be rounded up or rounded down, so that the point moves. That is, the movement of a point for turning its coordinates into integers may be conducted by rounding up or rounding down the decimal values of the coordinates of the point.

<Direction Toward the Projection Plane>

Further, in the movement of a point for turning its coordinates into integers, the point may be moved in a direction perpendicular to the projection plane and in the direction toward the projection plane, as in Method 1-1 shown in the third row from the top in the table in FIG. 6, for example.

<Example Projection Plane 1>

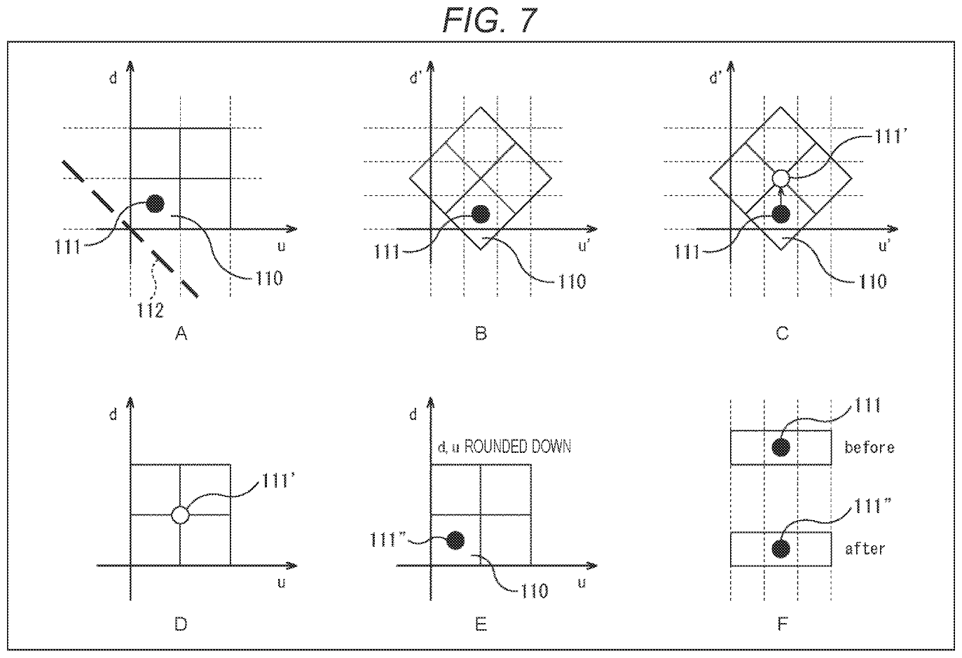

For example, a point 111 of a voxel 110 is projected onto a projection plane 112 that is a predetermined two-dimensional plane, as shown in A of FIG. 7. Here, the d-axis and the u-axis are coordinate axes perpendicular to each other in a basic coordinate system having coordinate axes along the respective sides of the voxel 110. The coordinates (u, d) of the point 111 in the basic coordinate system are defined as (0, 0). The projection plane 112 then passes through the lower left corner (the origin of the basic coordinate system) of the voxel 110 in the drawing, and has an angle of 45 degrees with respect to the u-axis and the d-axis. That is, the projection direction of the point 111 is the direction toward the lower left (45 degrees) in the drawing.

In a projection coordinate system that is a coordinate system having coordinate axes perpendicular to the projection plane, the coordinates are as shown in B of FIG. 7. In this case, the d′-axis is a coordinate system perpendicular to the projection plane 112, and the u′-axis is a coordinate system parallel to the projection plane 112. The coordinates (u′, d′) of the point 111 in this projection coordinate system are (2, 0).

As encoding/decoding is performed by the video-based approach, the position of the point 111 moves along the d′-axis (in a direction perpendicular to the projection plane 112) due to compression strain, as in C of FIG. 7, for example. The point 111 after this movement is defined as a point 111′. As shown in C of FIG. 7, the coordinates (u′, d′) of the point 111′ are (2, 1).

When this projection coordinate system is transformed into a basic coordinate system (that is, when the coordinate system is rotated), the coordinates of the point 111′ become (0.5, 0.5), as shown in D of FIG. 7. That is, this case is similar to the example cases shown in FIGS. 1 and 2.

Here, the decimal values of the u-coordinate and the d-coordinate are rounded down so that the point 111′ moves in a direction perpendicular to the projection plane 112 (the direction that is at an angle of 45 degrees and extends toward the lower left and the upper right in the drawing). When the point 111′ after this rounding process is defined as a point 111″, the coordinates of the point 111″ are (0, 0), as shown in E of FIG. 7. That is, the position of the point 111″ is the same as the position of the point 111 in A of FIG. 7, as in the example cases in FIGS. 1 and 2.

In other words, the point 111 and the point 111″ are both located in a direction perpendicular to the projection plane 112. Accordingly, in this case, the position of the point 111 and the position of the point 111″ as viewed from the projection plane 112 are the same as each other, as indicated by “before” and “after” in F of FIG. 7. That is, the position of the point 111 in the horizontal direction with respect to the projection plane does not change before encoding/decoding and (after the rounding process) after encoding/decoding.

<Example Projection Plane 2>

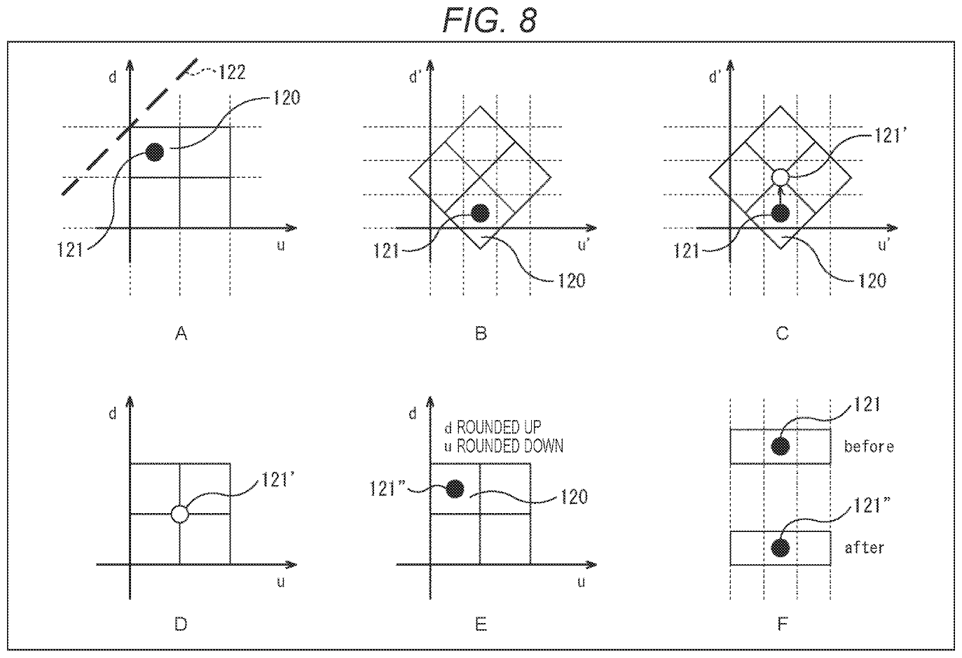

Next, a point 121 of a voxel 120 is projected onto a projection plane 122 that is a predetermined two-dimensional plane, as shown in A of FIG. 8, for example.

The d-axis and the u-axis are coordinate axes perpendicular to each other in a basic coordinate system having coordinate axes along the respective sides of the voxel 120. The coordinates (u, d) of the point 121 in the basic coordinate system are defined as (0, 1). The projection plane 122 then passes through the upper left corner of the voxel 120 in the drawing, and has an angle of 45 degrees with respect to the u-axis and the d-axis. That is, the projection direction of the point 121 is a direction toward the upper left (45 degrees) in the drawing.

In a projection coordinate system, the coordinates are as shown in B of FIG. 8. In this case, the d′-axis is a coordinate system perpendicular to the projection plane 122, and the u′-axis is a coordinate system parallel to the projection plane 122. The coordinates (u′, d′) of the point 121 in this projection coordinate system are (2, 0).

As encoding/decoding is performed by the video-based approach, the position of the point 121 moves along the d′-axis (in a direction perpendicular to the projection plane 122) due to compression strain, as in C of FIG. 8, for example. The point 121 after this movement is defined as a point 121′. As shown in C of FIG. 8, the coordinates (u′, d′) of the point 121′ are (2, 1).

When this projection coordinate system is transformed into a basic coordinate system (that is, when the coordinate system is rotated), the coordinates of the point 121′ become (0.5, 0.5), as shown in D of FIG. 8. That is, this case is similar to the example cases shown in FIGS. 3 and 4.

Here, the decimal value of the u-coordinate is rounded down, and the decimal value of the d-coordinate is rounded up so that the point 121′ moves in a direction perpendicular to the projection plane 122 (the direction that is at an angle of 45 degrees and extends toward the upper left and the lower right in the drawing). When the point 121′ after this rounding process is defined as a point 121″, the coordinates of the point 121″ are (0, 1), as shown in E of FIG. 8. That is, the position of the point 121″ is the same as the position of the point 121 in A of FIG. 8, which differs from the example cases in FIGS. 3 and 4.

In other words, the point 121 and the point 121″ are both located in a direction perpendicular to the projection plane 122. Accordingly, in this case, the position of the point 121 and the position of the point 121″ as viewed from the projection plane 122 are the same as each other, as indicated by “before” and “after” in F of FIG. 8. That is, the position of the point 121 in the horizontal direction with respect to the projection plane does not change before encoding/decoding and (after the rounding process) after encoding/decoding.

<Example Projection Plane 3>

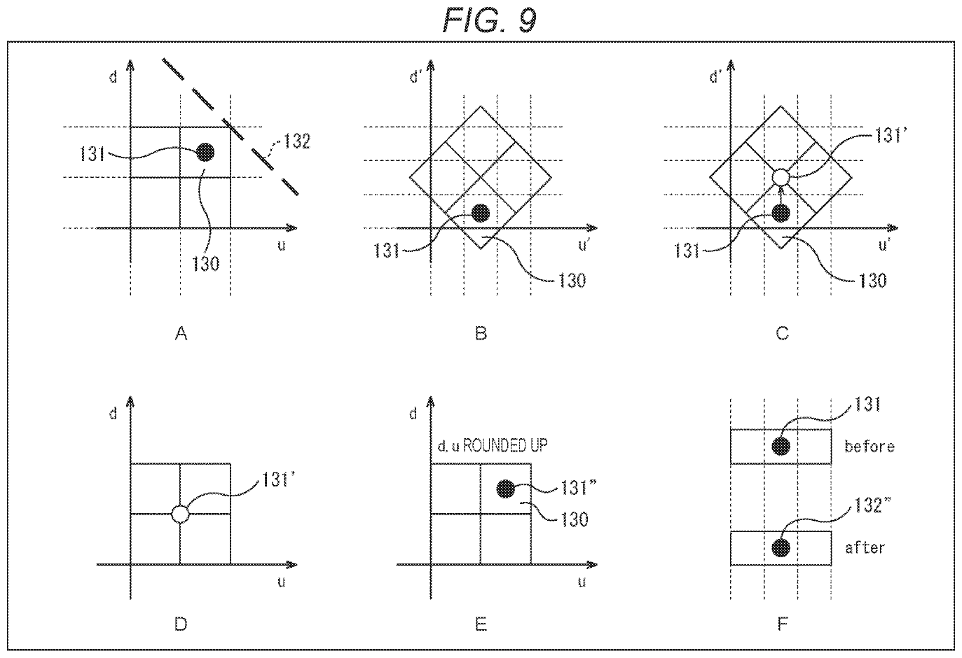

Next, a point 131 of a voxel 130 is projected onto a projection plane 132 that is a predetermined two-dimensional plane, as shown in A of FIG. 9, for example. The d-axis and the u-axis are coordinate axes perpendicular to each other in a basic coordinate system having coordinate axes along the respective sides of the voxel 130. The coordinates (u, d) of the point 131 in the basic coordinate system are defined as (1, 1). The projection plane 132 then passes through the upper right corner of the voxel 130 in the drawing, and has an angle of 45 degrees with respect to the u-axis and the d-axis. That is, the projection direction of the point 131 is a direction toward the upper right (45 degrees) in the drawing.

In a projection coordinate system, the coordinates are as shown in B of FIG. 9. In this case, the d′-axis is a coordinate system perpendicular to the projection plane 132, and the u′-axis is a coordinate system parallel to the projection plane 132. The coordinates (u′, d′) of the point 131 in this projection coordinate system are (2, 0).

As encoding/decoding is performed by the video-based approach, the position of the point 131 moves along the d′-axis (in a direction perpendicular to the projection plane 132) due to compression strain, as in C of FIG. 9, for example. The point 131 after this movement is defined as a point 131′. As shown in C of FIG. 9, the coordinates (u′, d′) of the point 131′ are (2, 1).

When this projection coordinate system is transformed into a basic coordinate system (that is, when the coordinate system is rotated), the coordinates of the point 131′ become (0.5, 0.5), as shown in D of FIG. 9.

Here, the decimal values of the u-coordinate and d-coordinate are rounded up so that the point 131′ moves in a direction perpendicular to the projection plane 132 (the direction that is at an angle of 45 degrees and extends toward the lower left and the upper right in the drawing). When the point 131′ after this rounding process is defined as a point 131″, the coordinates of the point 131″ are (1, 1), as shown in E of FIG. 9. That is, the position of the point 131″ is the same as the position of the point 131 in A of FIG. 9.

In other words, the point 131 and the point 131″ are both located in a direction perpendicular to the projection plane 132. Accordingly, in this case, the position of the point 131 and the position of the point 131″ as viewed from the projection plane 132 are the same as each other, as indicated by “before” and “after” in F of FIG. 9. That is, the position of the point 131 in the horizontal direction with respect to the projection plane does not change before encoding/decoding and (after the rounding process) after encoding/decoding.

<Example Projection Plane 4>

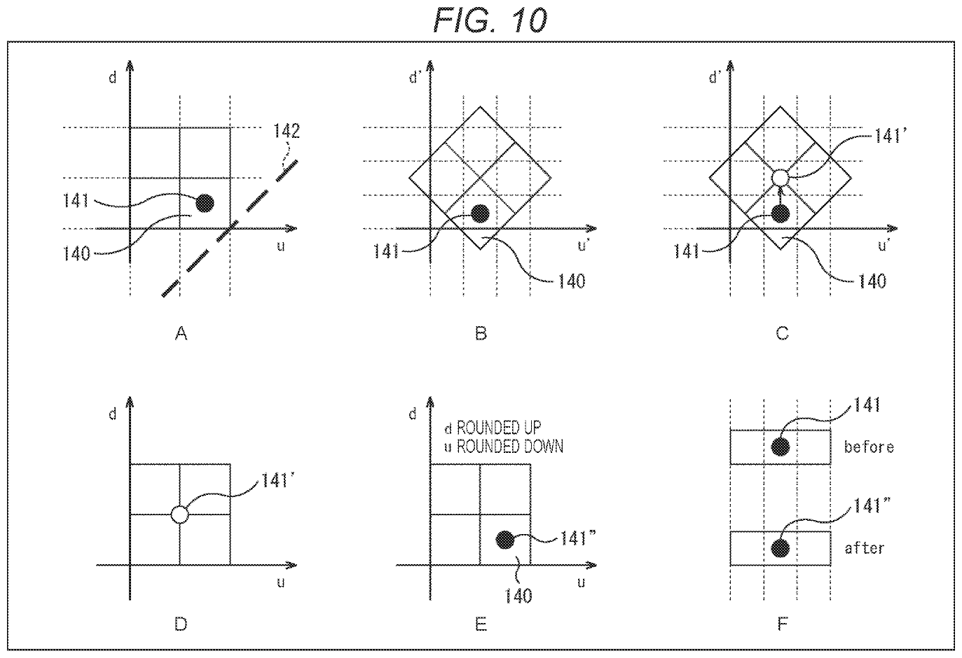

Next, a point 141 of a voxel 140 is projected onto a projection plane 142 that is a predetermined two-dimensional plane, as shown in A of FIG. 10, for example. The d-axis and the u-axis are coordinate axes perpendicular to each other in a basic coordinate system having coordinate axes along the respective sides of the voxel 140. The coordinates (u, d) of the point 141 in the basic coordinate system are defined as (1, 0). The projection plane 142 then passes through the lower right corner of the voxel 140 in the drawing, and has an angle of 45 degrees with respect to the u-axis and the d-axis. That is, the projection direction of the point 141 is a direction toward the lower right (45 degrees) in the drawing.

In a projection coordinate system, the coordinates are as shown in B of FIG. 10. In this case, the d′-axis is a coordinate system perpendicular to the projection plane 142, and the u′-axis is a coordinate system parallel to the projection plane 142. The coordinates (u′, d′) of the point 141 in this projection coordinate system are (2, 0).

As encoding/decoding is performed by the video-based approach, the position of the point 141 moves along the d′-axis (in a direction perpendicular to the projection plane 142) due to compression strain, as in C of FIG. 10, for example. The point 141 after this movement is defined as a point 141′. As shown in C of FIG. 10, the coordinates (u′, d′) of the point 141′ are (2, 1).

When this projection coordinate system is transformed into a basic coordinate system (that is, when the coordinate system is rotated), the coordinates of the point 141′ become (0.5, 0.5), as shown in D of FIG. 10.

Here, the decimal value of the u-coordinate is rounded up, and the decimal value of the d-coordinate is rounded down so that the point 141′ moves in a direction perpendicular to the projection plane 142 (the direction that is at an angle of 45 degrees and extends toward the upper left and the lower right in the drawing). When the point 141′ after this rounding process is defined as a point 141″, the coordinates of the point 141″ are (1, 0), as shown in E of FIG. 10. That is, the position is the same as the position of the point 141 shown in A of FIG. 10.

In other words, the point 141 and the point 141″ are both located in a direction perpendicular to the projection plane 132. Accordingly, in this case, the position of the point 141 and the position of the point 141″ as viewed from the projection plane 142 are the same as each other, as indicated by “before” and “after” in F of FIG. 10. That is, the position of the point 141 in the horizontal direction with respect to the projection plane does not change before encoding/decoding and (after the rounding process) after encoding/decoding.

As described above, in the case of any projection plane, the corresponding method described above is adopted, and a rounding process can be performed so as to move the points in a direction perpendicular to the projection plane. Thus, degradation of the subjective quality of the point cloud can be reduced.

<Selection of a Rounding Method>

In addition to the above explanation, the method for rounding the coordinates to move a point in a direction perpendicular to the projection plane is apparent on the basis of the orientation of the projection plane (projection direction). Therefore, the method of the rounding process corresponding to each candidate for the projection plane may be prepared in advance, and the method of the rounding process corresponding to the selected projection plane may be selected. That is, for each coordinate in the basic coordinate system of a point, whether to round up or round down the decimal value may be selected in accordance with the orientation of the projection plane. For example, a candidate for a pattern of rounding up or rounding down of the decimal value of each coordinate for moving a point may be prepared in advance for each candidate for a projection plane whose orientation is known, and the pattern to be adopted may be selected from among the candidates in accordance with the orientation of the projection plane to be adopted. That is, setting of the direction of movement of a point may be performed by selecting one of the candidates in accordance with the orientation of the projection plane.

For example, when the four projection planes (the projection plane 112, the projection plane 122, the projection plane 132, and the projection plane 142) described above are provided as the candidates, the following four patterns are prepared: (1) the decimal values of the u-coordinate and the d-coordinate are rounded down; (2) the decimal value of the u-coordinate is rounded down, and the decimal value of the d-coordinate is rounded up: (3) the decimal values of the u-coordinate and the d-coordinate are rounded up; and (4) the decimal value of the u-coordinate is rounded up, and the decimal value of the d-coordinate is rounded down. One of the four candidates is selected in accordance with the selected projection plane.

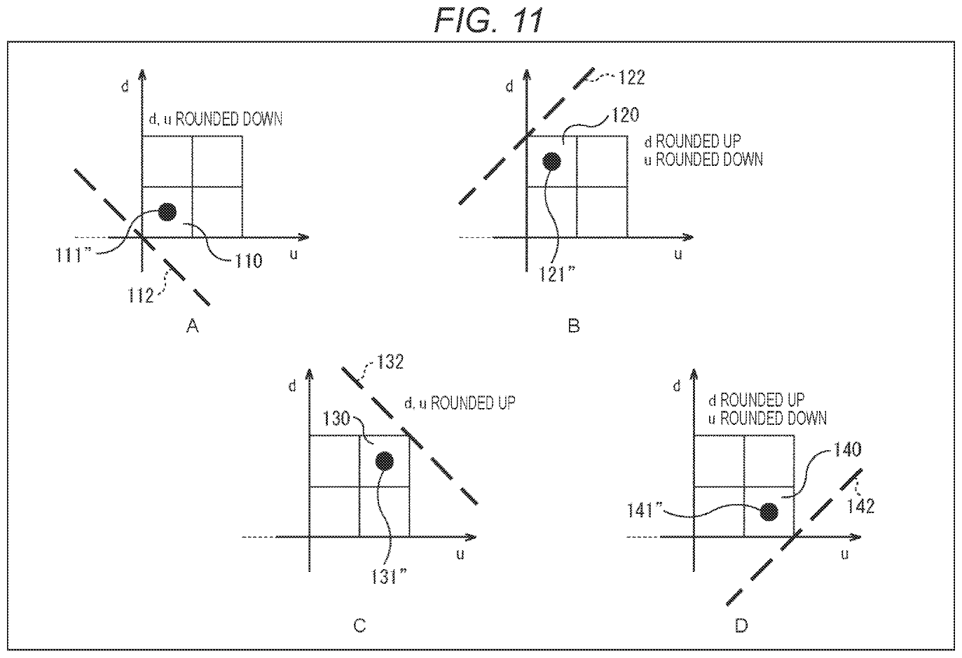

For example, when the point 111 is projected onto the projection plane 112 as shown in A of FIG. 11, the method (1) described above is adopted. That is, the decimal values of the u-coordinate and the d-coordinate of the point 111″ are rounded down. Also, when a point is projected onto the projection plane 122 as shown in B of FIG. 11, the method (2) described above is adopted. That is, the decimal value of the u-coordinate of the point 121″ is rounded down, and the decimal value of the d-coordinate is rounded up. Further, when a point is projected onto the projection plane 132 as shown in C of FIG. 11, the method (3) described above is adopted. That is, the decimal values of the u-coordinate and the d-coordinate of the point 131″ are rounded up. Also, when a point is projected onto the projection plane 142 as shown in D of FIG. 11, the method (4) described above is adopted. That is, the decimal value of the u-coordinate of the point 141″ is rounded up, and the decimal value of the d-coordinate is rounded down.

In this manner, the rounding method suitable for a projection plane can be more readily adopted.

<Direction Away from the Projection Plane>

Note that the direction of movement of a point is not limited to the above example. For example, a point may be moved in a direction perpendicular to the projection plane and in the direction away from the projection plane, as in Method 1-2 shown in the fourth row from the top in the table in FIG. 6. That is, in each of the examples shown in FIGS. 7 to 10, the point may be moved in the opposite direction.

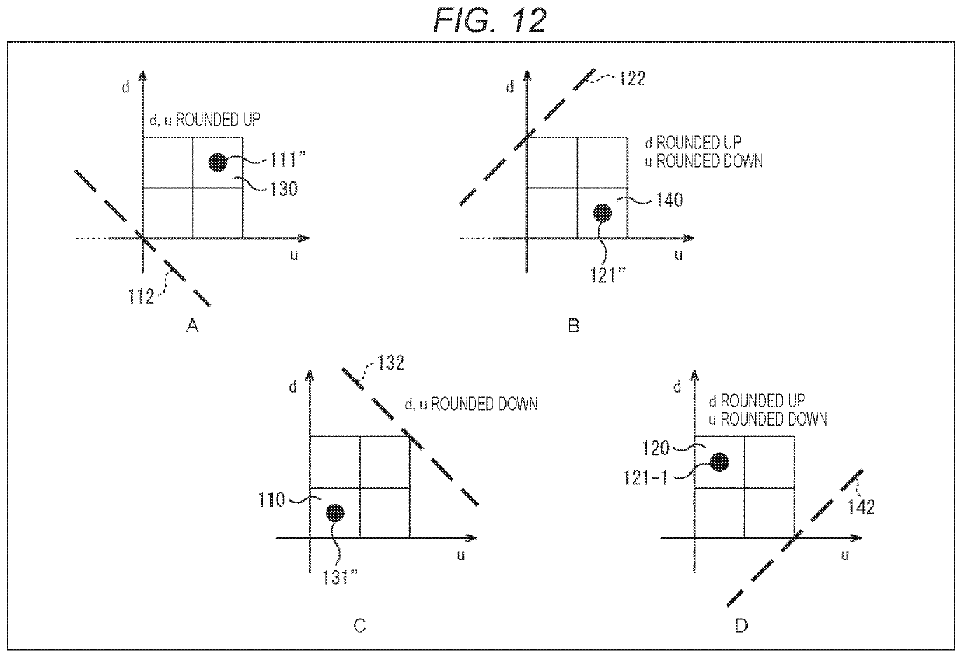

For example, as shown in A of FIG. 12, the decimal values of the u-coordinate and the d-coordinate of the point 111″ may be rounded up with respect to the projection plane 112. In this manner, the point can be moved in a direction opposite to that in the case shown in FIG. 7. In this case, both the point 111 and the point 111″ are also located in a direction perpendicular to the projection plane 112. Accordingly, the position of the point 111 in the horizontal direction with respect to the projection plane does not change before encoding/decoding and (after the rounding process) after encoding/decoding. Thus, degradation of the subjective quality of the point cloud can be reduced.

Also, as shown in B of FIG. 12, for example, the decimal value of the u-coordinate of the point 121″ may be rounded up while the d-coordinate is rounded down, with respect to the projection plane 122. In this manner, the point can be moved in a direction opposite to that in the case shown in FIG. 8. In this case, both the point 121 and the point 121″ are also located in a direction perpendicular to the projection plane 122. Accordingly, the position of the point 121 in the horizontal direction with respect to the projection plane does not change before encoding/decoding and (after the rounding process) after encoding/decoding. Thus, degradation of the subjective quality of the point cloud can be reduced.

Further, as shown in C of FIG. 12, for example, the decimal values of the u-coordinate and the d-coordinate of the point 131″ may be rounded down with respect to the projection plane 132. In this manner, the point can be moved in a direction opposite to that in the case shown in FIG. 9. In this case, both the point 131 and the point 131″ are also located in a direction perpendicular to the projection plane 132. Accordingly, the position of the point 131 in the horizontal direction with respect to the projection plane does not change before encoding/decoding and (after the rounding process) after encoding/decoding. Thus, degradation of the subjective quality of the point cloud can be reduced.

Also, as shown in D of FIG. 12, the decimal value of the u-coordinate of the point 141″ may be rounded down while the d-coordinate is rounded up, with respect to the projection plane 142. In this manner, the point can be moved in a direction opposite to that in the case shown in FIG. 10. In this case, both the point 141 and the point 141″ are also located in a direction perpendicular to the projection plane 142. Accordingly, the position of the point 141 in the horizontal direction with respect to the projection plane does not change before encoding/decoding and (after the rounding process) after encoding/decoding. Thus, degradation of the subjective quality of the point cloud can be reduced.

In the case of this direction, the method of the rounding process corresponding to each candidate for the projection plane may of course be prepared in advance, and the method of the rounding process corresponding to the selected projection plane may be selected.

For example, when the four projection planes (the projection plane 112, the projection plane 122, the projection plane 132, and the projection plane 142) described above are provided as the candidates, the following four patterns are prepared: (1) the decimal values of the u-coordinate and the d-coordinate are rounded up; (2) the decimal value of the u-coordinate is rounded up, and the decimal value of the d-coordinate is rounded down: (3) the decimal values of the u-coordinate and the d-coordinate are rounded down; and (4) the decimal value of the u-coordinate is rounded down, and the decimal value of the d-coordinate is rounded up. One of the four candidates is selected in accordance with the selected projection plane.

For example, when the point 111 is projected onto the projection plane 112 as shown in A of FIG. 12, the method (1) described above is adopted. That is, the decimal values of the u-coordinate and d-coordinate of the point 111″ are rounded up. Also, when a point is projected onto the projection plane 122 as shown in B of FIG. 12, the method (2) described above is adopted. That is, the decimal value of the u-coordinate of the point 121″ is rounded up, and the decimal value of the d-coordinate is rounded down. Further, when a point is projected onto the projection plane 132 as shown in C of FIG. 12, the method (3) described above is adopted. That is, the decimal values of the u-coordinate and the d-coordinate of the point 131″ are rounded down. Also, when a point is projected onto the projection plane 142 as shown in D of FIG. 12, the method (4) described above is adopted. That is, the decimal value of the u-coordinate of the point 141″ is rounded down, and the decimal value of the d-coordinate is rounded up.

In this manner, the rounding method suitable for a projection plane can be more readily adopted.

<Selection of Direction>

Note that any one of the above two directions (the direction toward the projection plane and the direction away from the projection plane) may be selected and adopted. In this manner, a rounding process can be performed so as to move a point in the direction suitable for the point cloud (the point distribution situation), for example. Thus, degradation of the subjective quality of the point cloud can be further reduced. Note that the unit of data by which the direction of point movement is selected may be any appropriate unit. For example, the direction of point movement may be set for each frame. Alternatively, the direction of point movement may be set for each patch, for example. It is of course possible to use some other data unit.

<Rounding Process in a Projection Coordinate System>

At that stage, the coordinates of a point may be rounded in a direction perpendicular to the projection plane prior to coordinate transform, as in Method 2 shown in the fifth row from the top in the table in FIG. 6, for example. That is, the coordinates of the projection coordinate system of a point may be updated, to move the point. That is, in a projection coordinate system that is a coordinate system having coordinate axes perpendicular to the projection plane, a point may be moved in a direction perpendicular to the projection plane so that the coordinates of the point in the basic coordinate system become integer values.

Alternatively, scale transform of the projection coordinate system may be performed in accordance with the basic coordinate system, for example, and the coordinates of the coordinate axes perpendicular to the projection plane in the projection coordinate system of a point may be turned into integers in the projection coordinate system subjected to the scale transform, to move the point.

<Direction Toward the Projection Plane>

Further, the decimal values of the coordinates of a coordinate axis perpendicular to the projection plane in the projection coordinate system of a point may be rounded down to move the point, as in Method 2-1 shown in the sixth row from the top in the table in FIG. 6, for example. That is, a point may be moved in the direction toward the projection plane.

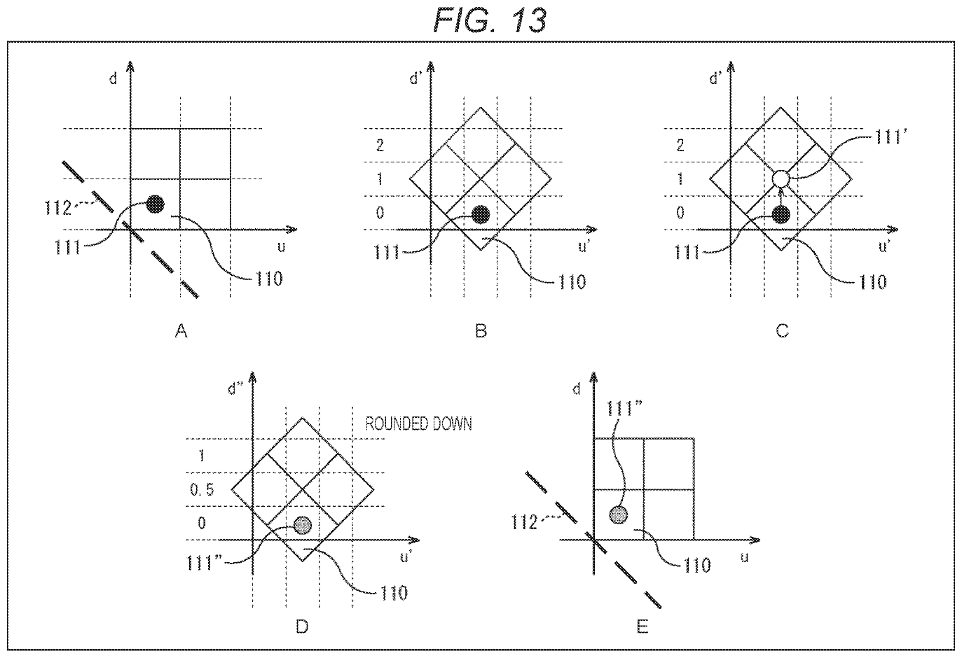

For example, a point 111 of a voxel 110 is projected onto the projection plane 112 that is a predetermined two-dimensional plane, as shown in A of FIG. 13. That is, this example is similar to A of FIG. 7. The coordinates (u, d) of the point 111 in the basic coordinate system are (0, 0), and the projection direction of the point 111 is the direction toward the lower left (45 degrees) in the drawing.

In a projection coordinate system that is a coordinate system having coordinate axes perpendicular to the projection plane, the coordinates are as shown in B of FIG. 13. The coordinates are similar to those in the case shown in B of FIG. 7, and the coordinates (u′, d′) of the point 111 in this projection coordinate system are (2, 0).

As encoding/decoding is performed by the video-based approach, the position of the point 111 moves along the d′-axis (in a direction perpendicular to the projection plane 112) due to compression strain, as in C of FIG. 13, for example. That is, the coordinates (u′, d′) of the point 111′ are (2, 1), as in C of FIG. 7.

In this case, in the process of rounding the coordinates of the point 111′ in the basic coordinate system, the point 111′ is moved in a direction perpendicular to the projection plane 112 and in the direction toward the projection plane 112 in this projection coordinate system (before transform into the basic coordinate system), which differs from the process in the case shown in D of FIG. 7.

First, the scale of the projection coordinate system is transformed in accordance with the basic coordinate system. In this case, since the projection coordinate system and the basic coordinate system are in a relationship of 45 degrees with each other, the scale of the projection coordinate system is reduced to ½, as shown in D of FIG. 13. In D of FIG. 13, the d′-axis is the coordinate axis obtained by subjecting the d′-axis to scale transform (to ½). As a result, the coordinates (u′, d″) of the point 111′ become (1, 0.5).

Further, as shown in D of FIG. 13, the decimal value of the coordinate of the coordinate axis of the point 111′ in the direction perpendicular to the projection plane is rounded down in the projection coordinate system after the scale transform. In the example case shown in D of FIG. 13, the d″-axis is the coordinate axis perpendicular to the projection plane 112. Therefore, the decimal value of the d″-coordinate of the point 111′ is rounded down. That is, the coordinates (u′, d″) of the point 111′ (which is the point 111″) after the movement are (1, 0).

When this projection coordinate system is transformed into a basic coordinate system (that is, when the coordinate system is rotated), the coordinates of the point 111″ become (0, 0), as shown in E of FIG. 13. That is, the position of the point 111″ is the same as the position of the point 111 shown in A of FIG. 13.

In other words, the point 111 and the point 111″ are both located in a direction perpendicular to the projection plane 112. That is, the position of the point 111 in the horizontal direction with respect to the projection plane does not change before encoding/decoding and (after the rounding process) after encoding/decoding. Thus, degradation of the subjective quality of the point cloud can be reduced.

This method can be applied to a projection plane having any orientation. That is, in the case of this method, to move a point in terms of projection coordinates, it is only required to round down the decimal value of the d″-coordinate of the point, regardless of the orientation of the projection plane. Accordingly, a rounding process can also be performed as shown in FIG. 13 when a point is projected onto a projection plane having some other orientation, such as the projection plane 122, the projection plane 132, or the projection plane 142 described above, for example. That is, it is not necessary to select a rounding method in accordance with the orientation of the projection plane, and an increase in load can be prevented.

<Direction Away from the Projection Plane>

Further, the decimal values of the coordinates of a coordinate axis perpendicular to the projection plane in the projection coordinate system of a point may be rounded up to move the point, as in Method 2-2 shown in the seventh row from the top in the table in FIG. 6, for example. That is, a point may be moved in the direction away from the projection plane.

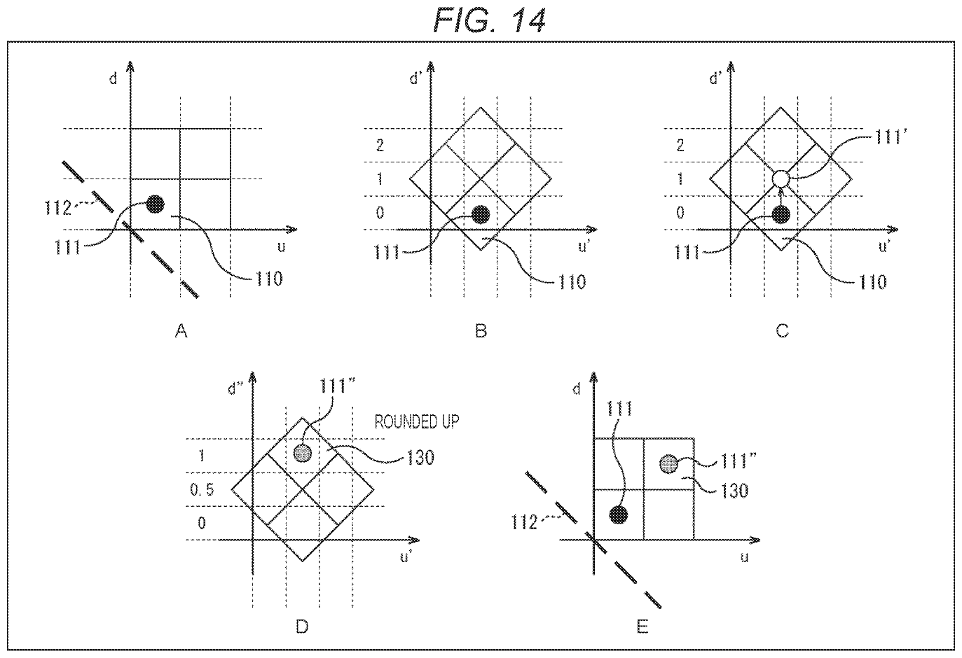

For example, a point 111 of a voxel 110 is projected onto the projection plane 112 that is a predetermined two-dimensional plane, as shown in A of FIG. 14. That is, this example is similar to A of FIG. 13. The coordinates (u, d) of the point 111 in the basic coordinate system are (0, 0), and the projection direction of the point 111 is the direction toward the lower left (45 degrees) in the drawing.

In a projection coordinate system that is a coordinate system having coordinate axes perpendicular to the projection plane, the coordinates are as shown in B of FIG. 14. That is, the coordinates are similar to those in the case shown in B of FIG. 13, and the coordinates (u′, d′) of the point 111 in this projection coordinate system are (2, 0).

As encoding/decoding is performed by the video-based approach, the position of the point 111 moves along the d′-axis (in a direction perpendicular to the projection plane 112) due to compression strain, as in C of FIG. 14, for example. That is, the coordinates (u′, d′) of the point 111′ are (2, 1), as in C of FIG. 13.

Further, in the process of rounding the coordinates of the point 111′ in the basic coordinate system, the point 111′ is moved in a direction perpendicular to the projection plane 112 and in the direction away from the projection plane 112 in this projection coordinate system (before transform into the basic coordinate system).

First, the scale of the projection coordinate system is transformed in accordance with the basic coordinate system. In this case, since the projection coordinate system and the basic coordinate system are in a relationship of 45 degrees with each other, the scale of the projection coordinate system is reduced to ½, as shown in D of FIG. 14. In D of FIG. 14, the d″-axis is the coordinate axis obtained by subjecting the d′-axis to scale transform (to ½). As a result, the coordinates (u′, d″) of the point 111′ become (1, 0.5).

Further, as shown in D of FIG. 14, the decimal value of the coordinate of the coordinate axis of the point 111′ in the direction perpendicular to the projection plane is rounded up in the projection coordinate system after the scale transform. In the example case shown in D of FIG. 14, the d″-axis is the coordinate axis perpendicular to the projection plane 112. Therefore, the decimal value of the d″-coordinate of the point 111′ is rounded up. That is, the coordinates (u′, d″) of the point 111′ (which is the point 111″) after the movement are (1, 1).

When this projection coordinate system is transformed into a basic coordinate system (that is, when the coordinate system is rotated), the coordinates of the point 111″ become (1, 1), as shown in E of FIG. 14. That is, the position of the point 111″ is different from the position of the point 111 shown in A of FIG. 13, but is located in a direction perpendicular to the projection plane 112.

That is, in this case, the position of the point 111 in the horizontal direction with respect to the projection plane does not change before encoding/decoding and (after the rounding process) after encoding/decoding, as when a point is moved in the direction toward the projection plane. Thus, degradation of the subjective quality of the point cloud can be reduced.

Furthermore, in this case where a point is moved in the direction away from the projection plane, this method can be applied to a projection plane having any orientation, as when a point is moved in the direction toward the projection plane. That is, it is not necessary to select a rounding method in accordance with the orientation of the projection plane, and an increase in load can be prevented.

<Orientation of a Projection Plane>

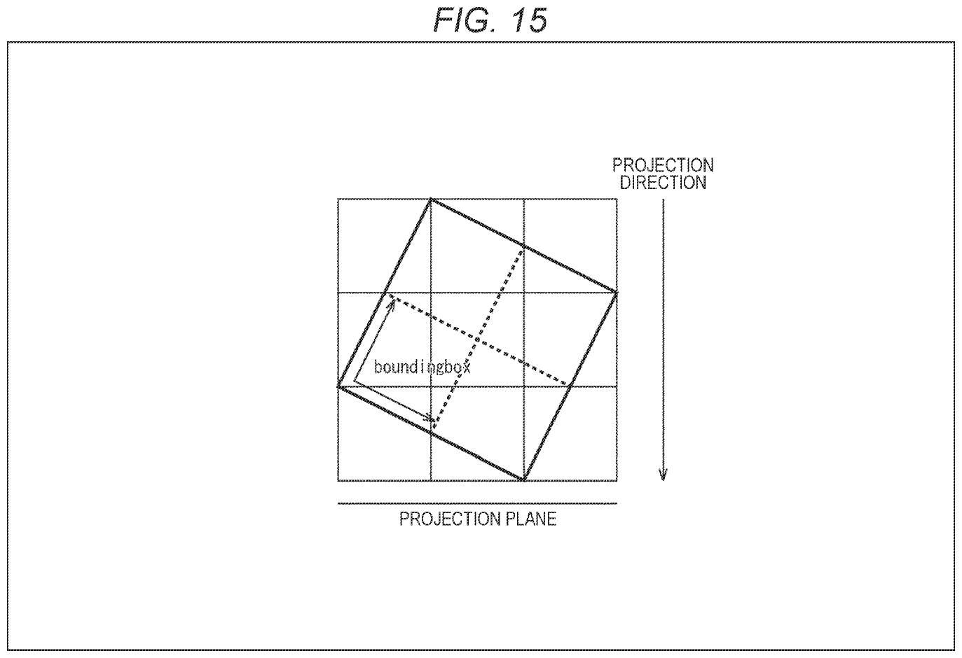

Note that a projection plane may have any orientation, and does not necessarily have a 45-degree orientation as in the above examples. That is, as shown in FIG. 15, a projection plane can be set at any angle with respect to a bounding box (voxel). That is, points can be projected in any direction. The above method can be applied when the projection plane has any orientation.

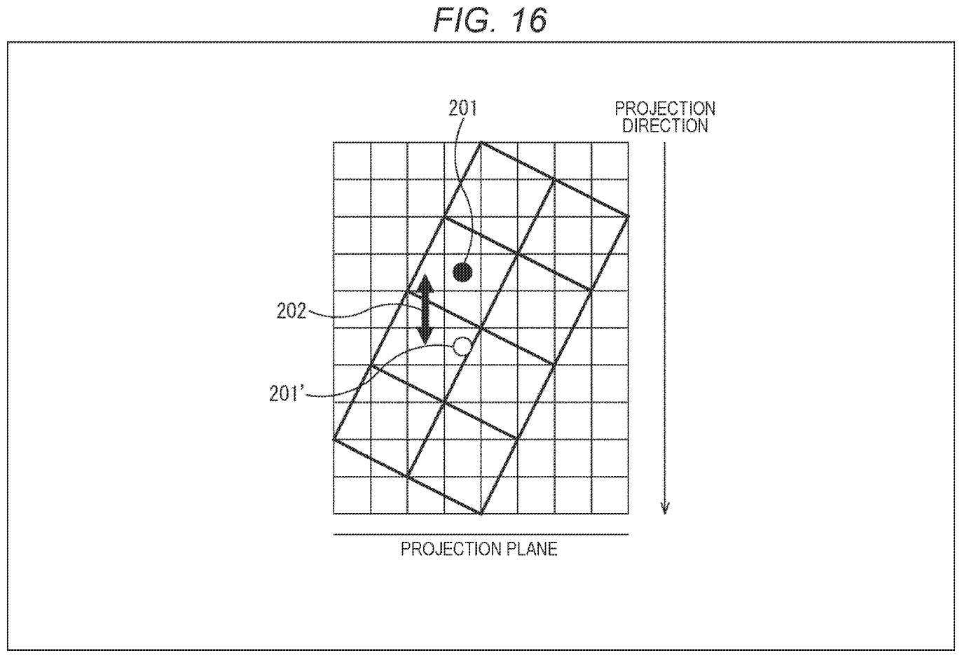

For example, as shown in FIG. 16, a point 201 moves in a direction perpendicular to the projection plane due to compression strain (double-headed arrow 202). The point 201 after the movement due to compression strain is called a point 201′.

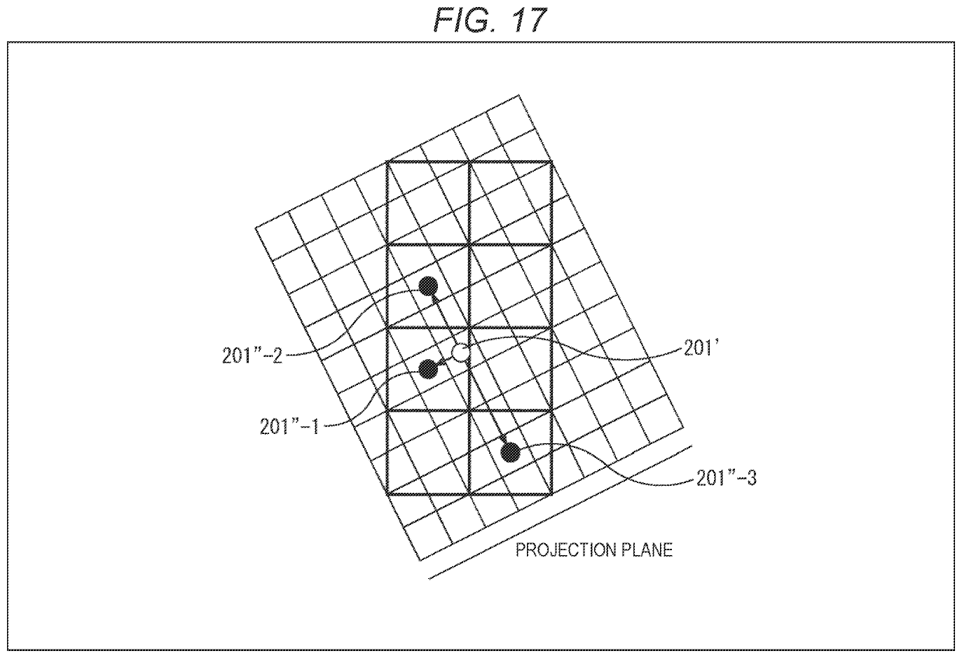

When the decimal values of the coordinates of the point 201′ are rounded in a conventional manner, the point 201′ moves to the position of a point 201″-1 shown in FIG. 17. In this case, the point 201′ moves in the horizontal direction with respect to the projection plane, and therefore, the subjective quality of the point cloud might be degraded.

To counter this, one of the methods described above is adopted, and the decimal values of the coordinates of the point 201′ are rounded, to move the point 201′ in a direction perpendicular to the projection plane, as shown in FIG. 17. For example, the point 201′ is moved in a direction perpendicular to the projection plane and in the direction away from the projection plane, and thus, is moved to the position of a point 201″-2. Alternatively, the point 201′ is moved in a direction perpendicular to the projection plane and in the direction toward the projection plane, and thus, is moved to the position of a point 201″-3, for example.

In this manner, the point 111 is prevented from moving in the horizontal direction with respect to the projection plane, and thus, degradation of the subjective quality of the point cloud can be reduced. That is, the present technology can be applied to a projection plane having any orientation.

<Selection of the Direction of Point Movement>

Note that, normally, the smaller the amount of the movement caused in a point by rounding of coordinates, the smaller the influence on the subjective quality of the point cloud, which is preferable. However, the amount of movement depends on the orientation (angle) of the projection plane. For example, in the example case shown in FIG. 17, the moving distance from the point 201′ to the point 201″-2 and the moving distance from the point 201′ to the point 201″-3 depend on the orientation (angle) of the projection plane.

Therefore, the direction of the movement to be caused in a point by rounding of the coordinates may be selected on the basis of the amount of the movement. For example, the closer one may be selected between a case where the coordinates of a point are rounded in the direction toward the projection plane and a case where the coordinates of a point are rounded in the direction away from the projection plane, as in Method 2-3 shown in the eighth row from the top in the table in FIG. 6.

That is, the movement caused in a point by rounding up the decimal value of the coordinate of the coordinate axis perpendicular to the projection plane of the projection coordinate system of the point, or the movement caused in a point by rounding down the decimal value of the coordinate of the coordinate axis perpendicular to the projection plane of the projection coordinate system of the point, whichever has the shorter point moving distance, may be selected.

For example, in FIG. 17, whether to move the point 201′ to the position of the point 201″-2, or whether to move the point 201′ to the position of the point 201″-3 is selected on the basis of the movement distances. For example, the case with the shorter moving distance is selected. In this manner, it is possible to prevent an increase in the influence of point movement on the subjective quality of the point cloud (due to rounding of coordinates).

Note that the direction of point movement may be selected for any data unit. For example, the amounts of movement of the respective points may be compared in each data unit, and the direction in which the amount of movement is small as a whole may be selected. For example, the direction of point movement may be set for each frame. Alternatively, the direction of point movement may be set for each patch, for example. It is of course possible to use some other data unit.

<Application of the Present Technology Depending on the Accuracy of an Occupancy Map>

Note that, a point coordinate rounding method may be selected for each patch in accordance with the accuracy of the occupancy map (Occupancy Precision), as in Method 3 shown in the ninth row from the top in the table in FIG. 6, for example. That is, a point may be moved in a direction perpendicular to the projection plane, in accordance with the accuracy of the occupancy map. For example, when the accuracy of the occupancy map (Occupancy Precision) is 1, the present technology may be applied, and a point may be moved in a direction perpendicular to the projection plane. Such control can be performed for each appropriate data unit. For example, such control may be performed for each patch.

Note that this Method 3 can be adopted in conjunction with Method 1. Also, this Method 3 can be adopted in conjunction with Method 2.

<Point Duplication>

Further, in the rounding of coordinates described above, a point may be duplicated as in Method 4 shown in the tenth row from the top in the table in FIG. 6, for example. That is, a point projected onto a projection plane may be disposed at a plurality of locations in a three-dimensional space, to reconstruct the point cloud.

As a point is duplicated in this manner, the number of points increases, and thus, degradation of the subjective quality of the point cloud can be reduced.

For example, both a point rounded in the direction toward the projection plane and a point rounded in the direction away from the projection plane may be generated and be disposed in a three-dimensional space, as in Method 4-1 shown in the eleventh row from the top in the table in FIG. 6. That is, one point projected onto the projection plane may be moved both in the direction toward the projection plane and in the direction away from the projection plane in a direction perpendicular to the projection plane, and the point cloud including the respective points after the movement may be reconstructed.

In this manner, not only the number of points increases, but also the movement of points in the horizontal direction with respect to the projection plane is prevented. Thus, degradation of the subjective quality of the point cloud can be further reduced.

Also, a point having its coordinates rounded may be generated while the point having the unrounded coordinates remains, and both of the points may be disposed in a three-dimensional space, as in Method 4-2 shown in the twelfth row from the top in the table in FIG. 6, for example. That is, the point cloud including the point after being moved in a direction perpendicular to the projection plane and the point before being moved may be reconstructed.

In this manner, not only the number of points increases, but also the movement of points in the horizontal direction with respect to the projection plane is prevented. Thus, degradation of the subjective quality of the point cloud can be further reduced. Furthermore, as the calculation related to the rounding of each point needs to be performed only once, the increase in load can be made smaller than that in the case of Method 4-1.

A point before movement, the point moved in the direction toward the projection plane, and the point moved in the direction away from the projection plane may of course be arranged in a three-dimensional space, and the point cloud including these points may be reconstructed.

Noted that this Method 4 (either Method 4-1 or Method 4-2) can be adopted in conjunction with Method 1. This Method 4 can also be adopted in conjunction with Method 2. Further, this Method 4 can be adopted in conjunction with Method 3.

### 2. First Embodiment

<Encoding Device>

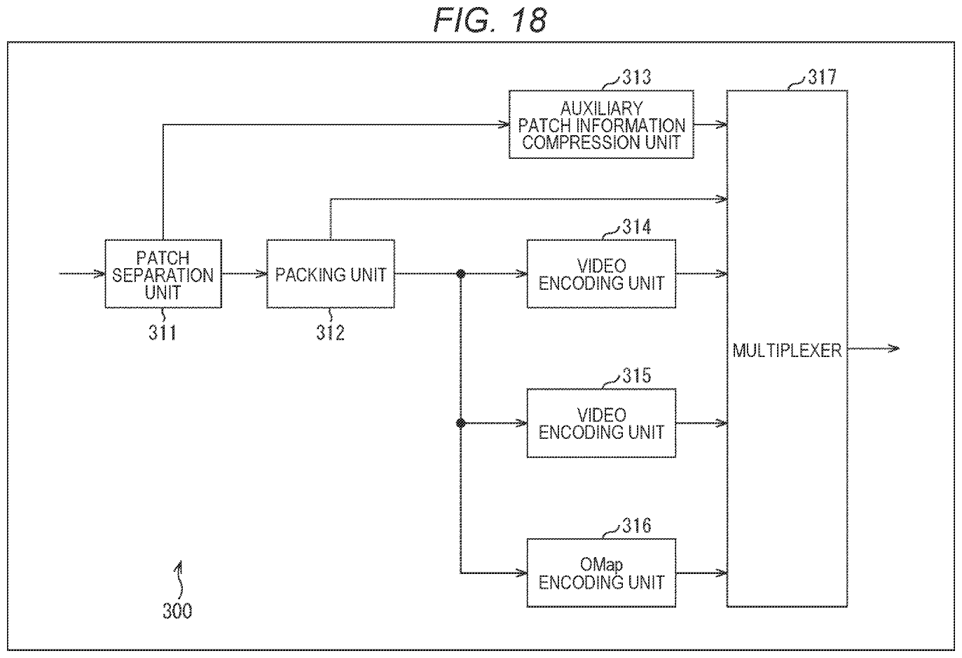

FIG. 18 is a block diagram showing an example configuration of an encoding device. An encoding device 300 shown in FIG. 18 is a device that projects 3D data such as a point cloud onto a two-dimensional plane and performs encoding by an encoding method for two-dimensional images (an encoding device to which the video-based approach is applied).

Note that FIG. 18 shows the principal components and aspects such as processing units and a data flow, but FIG. 18 does not necessarily show all the components and aspects. That is, in the encoding device 300, there may be a processing unit that is not shown as a block in FIG. 18, or there may be a process or data flow that is not shown as an arrow or the like in FIG. 18.

As shown in FIG. 18, the encoding device 300 includes a patch separation unit 311, a packing unit 312, an auxiliary patch information compression unit 313, a video encoding unit 314, a video encoding unit 315, an OMap encoding unit 316, and a multiplexer 317.

The patch separation unit 311 performs a process related to separation of 3D data. For example, the patch separation unit 311 acquires 3D data (a point cloud, for example) that is input to the encoding device 300 and indicates a three-dimensional structure. The patch separation unit 311 also separates the acquired 3D data into a plurality of small regions (connection components), projects each of the small regions of the 3D data onto a two-dimensional plane, and generates a patch of geometry data and a patch of attribute data.

The patch separation unit 311 supplies information regarding each of the generated patches to the packing unit 312. The patch separation unit 311 also supplies auxiliary patch information, which is information regarding the separation, to the auxiliary patch information compression unit 313.

The packing unit 312 performs a process related to data packing. For example, the packing unit 312 acquires the information regarding the patches supplied from the patch separation unit 311. The packing unit 312 also places each of the acquired patches in a two-dimensional image, to pack the patches as a video frame. For example, the packing unit 312 packs the patch of geometry data as a video frame, and generates a geometry video frame(s). The packing unit 312 also packs the patch of attribute data as a video frame, and generates a color video frame(s). Further, the packing unit 312 generates an occupancy map indicating the presence or absence of patches.

The packing unit 312 supplies these pieces of data to the processing units in the stage that follows. For example, the packing unit 312 supplies the geometry video frame to the video encoding unit 314, supplies the color video frame to the video encoding unit 315, and supplies the occupancy map to the OMap encoding unit 316. The packing unit 312 also supplies control information regarding the packing to the multiplexer 317.

The auxiliary patch information compression unit 313 performs a process related to compression of auxiliary patch information. For example, the auxiliary patch information compression unit 313 acquires the auxiliary patch information supplied from the patch separation unit 311. The auxiliary patch information compression unit 313 encodes (compresses) the acquired auxiliary patch information. The auxiliary patch information compression unit 313 supplies the resultant encoded data of the auxiliary patch information to the multiplexer 317.

The video encoding unit 314 performs a process related to encoding of a geometry video frame. For example, the video encoding unit 314 acquires the geometry video frame supplied from the packing unit 312. The video encoding unit 314 also encodes the acquired geometry video frame by an appropriate encoding method for two-dimensional images, such as AVC or HEVC, for example. The video encoding unit 314 supplies the encoded data of the geometry video frame obtained by the encoding, to the multiplexer 317.

The video encoding unit 315 performs a process related to encoding of a color video frame. For example, the video encoding unit 315 acquires the color video frame supplied from the packing unit 312. The video encoding unit 315 also encodes the acquired color video frame by an appropriate encoding method for two-dimensional images, such as AVC or HEVC, for example. The video encoding unit 315 supplies the encoded data of the color video frame obtained by the encoding, to the multiplexer 317.

The OMap encoding unit 316 performs a process related to encoding of an occupancy map. For example, the OMap encoding unit 316 acquires the occupancy map supplied from the packing unit 312. The OMap encoding unit 316 also encodes the acquired occupancy map by an appropriate encoding method such as arithmetic encoding, for example. The OMap encoding unit 316 supplies the encoded data of the occupancy map obtained by the encoding, to the multiplexer 317.

The multiplexer 317 performs a process related to multiplexing. For example, the multiplexer 317 acquires the encoded data of the auxiliary patch information supplied from the auxiliary patch information compression unit 313. The multiplexer 317 also acquires the control information regarding packing supplied from the packing unit 312, for example. The multiplexer 317 further acquires the encoded data of the geometry video frame supplied from the video encoding unit 314, for example. The multiplexer 317 also acquires the encoded data of the color video frame supplied from the video encoding unit 315, for example. The multiplexer 317 further acquires the encoded data of the occupancy map supplied from the OMap encoding unit 316, for example.

The multiplexer 317 multiplexes those acquired pieces of information, to generate a bitstream. The multiplexer 317 outputs the generated bitstream to the outside of the encoding device 300.

Note that these processing units (from the patch separation unit 311 to the multiplexer 317) have any appropriate configurations. For example, each processing unit may be formed with a logic circuit that performs the processes described above. Alternatively, each processing unit may include a central processing unit (CPU), a read only memory (ROM), a random access memory (RAM), and the like, for example, and execute a program using these components, to perform the processes described above. Each processing unit may of course have both configurations, and perform some of the processes described above with a logic circuit, and the other by executing a program. The configurations of the respective processing units may be independent of one another. For example, one processing unit may perform some of the processes described above with a logic circuit while the other processing units perform the processes described above by executing a program.

Further, some other processing unit may perform the processes described above both with a logic circuit and by executing a program.

<Flow in an Encoding Process>

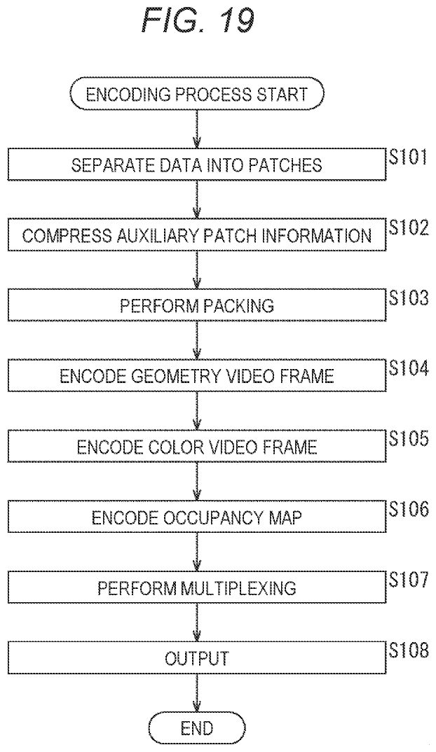

An example flow in an encoding process to be performed by the encoding device 300 is now described, with reference to a flowchart shown in FIG. 19.

When an encoding process is started, the patch separation unit 311 of the encoding device 300 in step S101 separates 3D data (a point cloud, for example) into small regions (connection components), projects the data of each small region onto a two-dimensional plane (a projection plane), and generates a patch of geometry data and a patch of attribute data.

In step S102, the auxiliary patch information compression unit 313 compresses the auxiliary patch information obtained through the process in step S101. In step S103, the packing unit 312 packs each patch generated by the patch separation unit 311, to generate a geometry video frame and a color video frame. The packing unit 312 also generates an occupancy map.

In step S104, the video encoding unit 314 encodes the geometry video frame generated through the process in step S103, by an encoding method for two-dimensional images. In step S105, the video encoding unit 315 encodes the color video frame generated through the process in step S103, by an encoding method for two-dimensional images. In step S106, the OMap encoding unit 316 encodes the occupancy map obtained through the process in step S103.

In step S107, the multiplexer 317 multiplexes the various pieces of information generated as described above, and generates a bitstream including these pieces of information. In step S108, the multiplexer 317 outputs the bitstream generated through the process in step S107, to the outside of the encoding device 300. When the process in step S108 is completed, the encoding process comes to an end.

<Decoding Device>

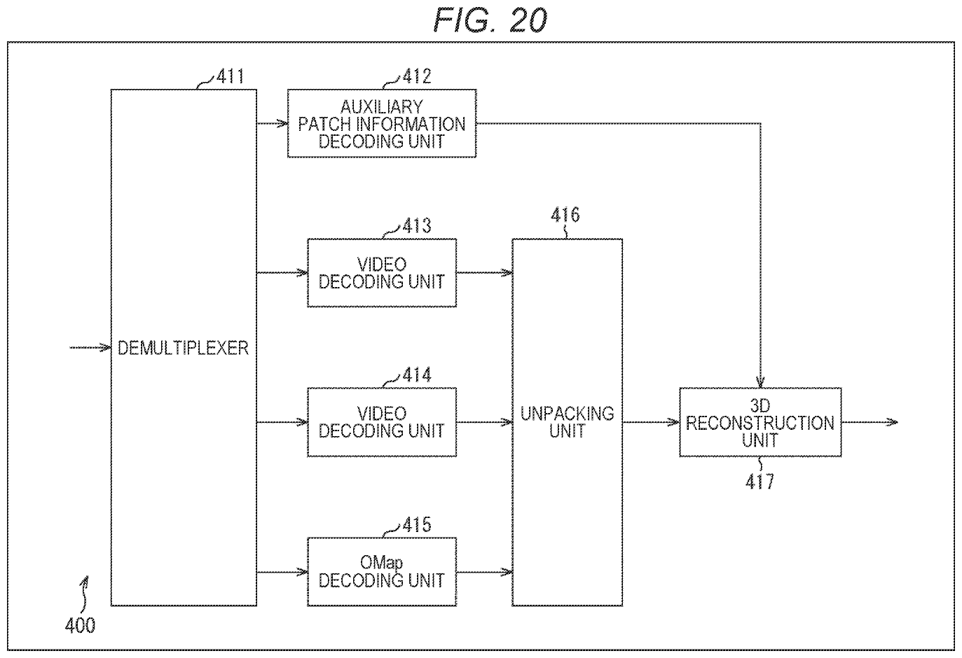

FIG. 20 is a block diagram showing an example configuration of a decoding device as an embodiment of an image processing apparatus to which the present technology is applied. A decoding device 400 shown in FIG. 20 is a device (a decoding device to which the video-based approach is applied) that decodes, by a decoding method for two-dimensional images, encoded data generated through projection of 3D data such as a point cloud onto a two-dimensional plane, and reconstructs the 3D data. The decoding device 400 is a decoding device compatible with the encoding device 300 shown in FIG. 18, and can decode a bitstream generated by the encoding device 300 to reconstruct 3D data.

Note that FIG. 20 shows the principal components and aspects such as processing units and a data flow, but FIG. 20 does not necessarily show all the components and aspects. That is, in the decoding device 400, there may be a processing unit that is not shown as a block in FIG. 20, or there may be processing or a data flow that is not indicated by arrows or the like in FIG. 20.

As shown in FIG. 20, the decoding device 400 includes a demultiplexer 411, an auxiliary patch information decoding unit 412, a video decoding unit 413, a video decoding unit 414, an OMap decoding unit 415, an unpacking unit 416, and a 3D reconstruction unit 417.

The demultiplexer 411 performs a process related to data demultiplexing. For example, the demultiplexer 411 can acquire a bitstream input to the decoding device 400. This bitstream is supplied from the encoding device 300, for example.

The demultiplexer 411 can also demultiplex this bitstream. For example, the demultiplexer 411 can extract encoded data of auxiliary patch information from the bitstream by the demultiplexing. The demultiplexer 411 can also extract encoded data of a geometry video frame from the bitstream by the demultiplexing. Further, the demultiplexer 411 can also extract encoded data of a color video frame from the bitstream by the demultiplexing. The demultiplexer 411 can also extract encoded data of an occupancy map from the bitstream by the demultiplexing.

Further, the demultiplexer 411 can supply the extracted data to the processing units in the stage that follow. For example, the demultiplexer 411 can supply the extracted encoded data of auxiliary patch information to the auxiliary patch information decoding unit 412. The demultiplexer 411 can also supply the extracted encoded data of a geometry video frame to the video decoding unit 413. Further, the demultiplexer 411 can also supply the extracted encoded data of a color video frame to the video decoding unit 414. The demultiplexer 411 can also supply the extracted encoded data of an occupancy map to the OMap decoding unit 415.

The demultiplexer 411 can also extract control information regarding the packing from the bitstream by the demultiplexing, and supplies the extracted control information to the unpacking unit 416.

The auxiliary patch information decoding unit 412 performs a process related to decoding of encoded data of auxiliary patch information. For example, the auxiliary patch information decoding unit 412 can acquire the encoded data of auxiliary patch information supplied from the demultiplexer 411. The auxiliary patch information decoding unit 412 can also decode the encoded data, and generate the auxiliary patch information. Further, the auxiliary patch information decoding unit 412 can supply the auxiliary patch information to the 3D reconstruction unit 417.

The video decoding unit 413 performs a process related to decoding of encoded data of a geometry video frame. For example, the video decoding unit 413 can acquire the encoded data of a geometry video frame supplied from the demultiplexer 411. The video decoding unit 413 can also decode the encoded data, and generate the geometry video frame. Further, the video decoding unit 413 can supply the geometry video frame to the unpacking unit 416.

The video decoding unit 414 performs a process related to decoding of encoded data of a color video frame. For example, the video decoding unit 414 can acquire the encoded data of a color video frame supplied from the demultiplexer 411. The video decoding unit 414 can also decode the encoded data, and generate the color video frame. Further, the video decoding unit 414 can supply the color video frame to the unpacking unit 416.

The OMap decoding unit 415 performs a process related to decoding of encoded data of an occupancy map. For example, the OMap decoding unit 415 can acquire the encoded data of an occupancy map supplied from the demultiplexer 411. The OMap decoding unit 415 can also decode the encoded data, and generate the occupancy map. Further, the OMap decoding unit 415 can supply the occupancy map to the unpacking unit 416.

The unpacking unit 416 performs a process related to unpacking. For example, the unpacking unit 416 can acquire the control information regarding the packing supplied from the demultiplexer 411, for example. The unpacking unit 416 can also acquire the geometry video frame supplied from the video decoding unit 413. Further, the unpacking unit 416 can acquire the color video frame supplied from the video decoding unit 414. The unpacking unit 416 can also acquire the occupancy map supplied from the OMap decoding unit 415.

Further, the unpacking unit 416 can unpack the geometry video frame and the color video frame on the basis of the acquired control information and the acquired occupancy map, and extract patches or the like of the geometry data and the attribute data.

The unpacking unit 416 can also supply the patches or the like of the geometry data and the attribute data to the 3D reconstruction unit 417.

The 3D reconstruction unit 417 performs a process related to reconstruction of 3D data. For example, the 3D reconstruction unit 417 can acquire the auxiliary patch information supplied from the auxiliary patch information decoding unit 412. The 3D reconstruction unit 417 can also acquire the patch or the like of the geometry data supplied from the unpacking unit 416. Further, the 3D reconstruction unit 417 can acquire the patch or the like of the attribute data supplied from the unpacking unit 416. The 3D reconstruction unit 417 can also acquire the occupancy map supplied from the unpacking unit 416.

Further, the 3D reconstruction unit 417 adopts the present technology described above in <1. Point Cloud Reconstruction>, and reconstructs 3D data (a point cloud, for example) using those pieces of information. The 3D reconstruction unit 417 outputs the 3D data obtained through such processes to the outside of the decoding device 400.

This 3D data is supplied to a display unit, for example. The image of the 3D data is then displayed, is recorded on a recording medium, or is supplied to some other device via communication.

Note that these processing units (from the demultiplexer 411 to the 3D reconstruction unit 417) have any appropriate configurations. For example, each processing unit may be formed with a logic circuit that performs the processes described above. Alternatively, each processing unit may also include a CPU, ROM, RAM, and the like, for example, and execute a program using them, to perform the processes described above. Each processing unit may of course have both configurations, and perform some of the processes described above with a logic circuit, and the other by executing a program. The configurations of the respective processing units may be independent of one another. For example, one processing unit may perform some of the processes described above with a logic circuit while the other processing units perform the processes described above by executing a program. Further, some other processing unit may perform the processes described above both with a logic circuit and by executing a program.

<3D Reconstruction Unit>

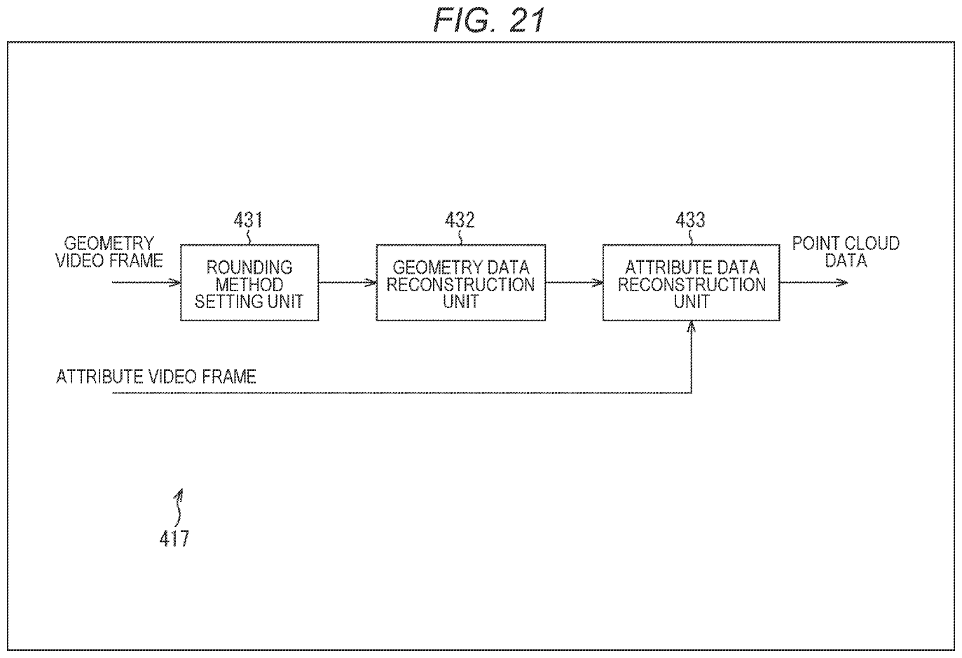

FIG. 21 is a block diagram showing a typical example configuration of the 3D reconstruction unit 417. As shown in FIG. 21, the 3D reconstruction unit 417 includes a rounding method setting unit 431, a geometry data reconstruction unit 432, and an attribute data reconstruction unit 433.

The rounding method setting unit 431 performs a process related to setting of a rounding method. For example, the rounding method setting unit 431 can acquire the patch or the like of the geometry data supplied from the unpacking unit 416. Using the acquired geometry data, the rounding method setting unit 431 can also set a rounding method in accordance with the orientation of the point projection plane. Further, the rounding method setting unit 431 can supply the patch or the like of the geometry data, the setting of the rounding method, and the like to the geometry data reconstruction unit 432.

The geometry data reconstruction unit 432 performs a process relating to reconstruction of geometry data. For example, the geometry data reconstruction unit 432 can acquire the patch or the like of the geometry data, the setting of the rounding method, and the like supplied from the rounding method setting unit 431. The geometry data reconstruction unit 432 can also reconstruct the geometry data of the point cloud by adopting the present technology described above in <1. Point Cloud Reconstruction>, using the acquired data, the setting, and the like. Further, the geometry data reconstruction unit 432 can supply the reconstructed geometry data and the like to the attribute data reconstruction unit 433.

The attribute data reconstruction unit 433 performs a process relating to reconstruction of attribute data. For example, the attribute data reconstruction unit 433 can acquire the geometry data and the like supplied from the geometry data reconstruction unit 432. The attribute data reconstruction unit 433 can also acquire the patch or the like of the attribute data supplied from the unpacking unit 416. Further, using the acquired data and the like, the attribute data reconstruction unit 433 can reconstruct the attribute data of the point cloud, and generate point cloud data. Further, the attribute data reconstruction unit 433 can output the generated point cloud data and the like to the outside of the decoding device 400.

As described above, the geometry data reconstruction unit 432 can adopt the present technology described above in <1. Point Cloud Reconstruction>. For example, the geometry data reconstruction unit 432 can reconstruct the geometry data, using any of the methods shown in FIG. 6. Also, for example, the geometry data reconstruction unit 432 can reconstruct the geometry data, using a combination of a plurality of methods among the methods shown in FIG. 6.

That is, the geometry data reconstruction unit 432 can round the coordinates of the points and turn the coordinates into integers, so as to reduce movement of the points in a horizontal direction with respect to the projection plane. Thus, (the 3D reconstruction unit 417 of) the decoding device 400 can reduce degradation of the subjective quality of the point cloud.

<Flow in a Decoding Process>

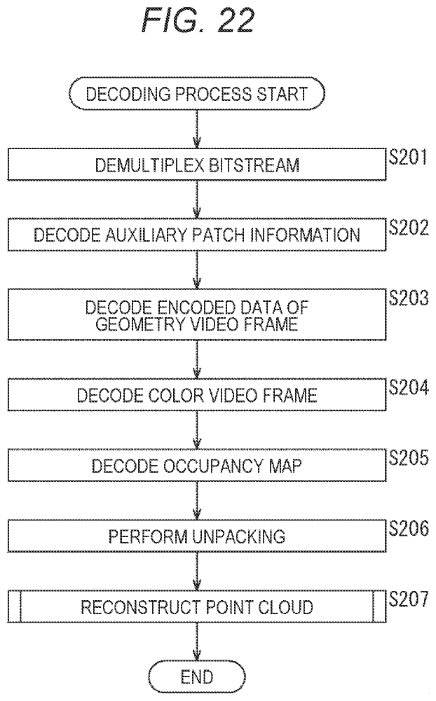

An example flow in a decoding process to be performed by such a decoding device 400 is now described, with reference to a flowchart shown in FIG. 22.

When a decoding process is started, the demultiplexer 411 of the decoding device 400 demultiplexes a bitstream in step S201. In step S202, the auxiliary patch information decoding unit 412 decodes the encoded data of auxiliary patch information extracted from the bitstream by the process in step S201.

In step S203, the video decoding unit 413 decodes the encoded data of a geometry video frame extracted from the bitstream by the process in step S201. In step S204, the video decoding unit 414 decodes the encoded data of a color video frame extracted from the bitstream by the process in step S201. In step S205, the OMap decoding unit 415 decodes the encoded data of an occupancy map extracted from the bitstream by the process in step S201.

In step S206, the unpacking unit 416 unpacks the geometry video frame and the color video frame, on the basis of the control information regarding the packing and the occupancy map.

In step S207, the 3D reconstruction unit 417 performs a point cloud reconstruction process by adopting the present technology described above in <1. Point Cloud Reconstruction>, and reconstructs 3D data such as a point cloud, for example, on the basis of the auxiliary patch information obtained in step S202 and the various kinds of information obtained in step S206. When the process in step S207 is completed, the decoding process comes to an end.

<Flow 1 in the Point Cloud Reconstruction Process>

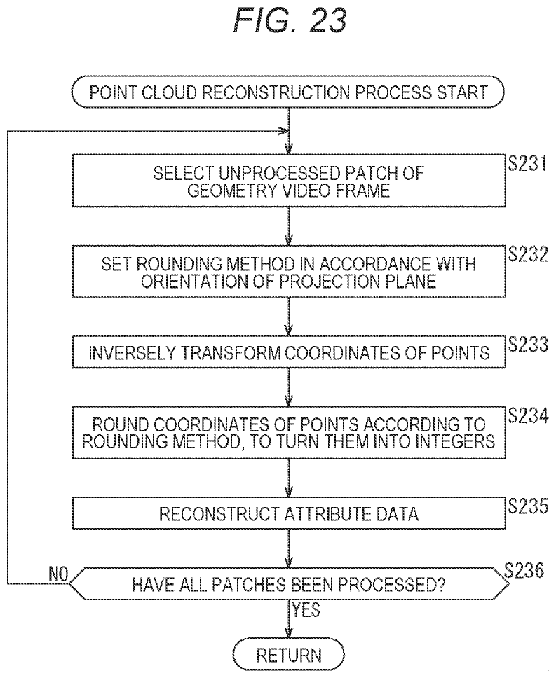

A case where the coordinates of points are rounded in the basic coordinate system in step S207 in FIG. 22 (a case where “Method 1 (Method 1-1 and Method 1-2)” shown in FIG. 6 is adopted) is now described. In this case, the point cloud reconstruction process is performed in a flow like a flowchart shown in FIG. 23, for example.

In this case, when the point cloud reconstruction process is started, the rounding method setting unit 431 of the 3D reconstruction unit 417 selects an unprocessed patch of the geometry data as the processing target in step S231.

In step S232, the rounding method setting unit 431 sets the method for rounding the coordinates of the points, in accordance with the orientation of the projection plane of the patch. Note that, here, the rounding method setting unit 431 may select the direction in which the points are moved by the rounding of the coordinates, as described above in <1. Point Cloud Reconstruction>.

In step S233, the geometry data reconstruction unit 432 inversely transforms the coordinates of each point of the processing target patch. That is, the geometry data reconstruction unit 432 transforms the coordinates of each point in the projection coordinate system into the coordinates of the basic coordinate system.

In step S234, the geometry data reconstruction unit 432 rounds the coordinates of each point of the processing target patch in the basic coordinate system and turns the coordinates into integers, using the method set in step S232. That is, the geometry data reconstruction unit 432 turns the respective coordinates of each point in the basic coordinate system into integers so that the points move in a direction perpendicular to the projection plane.

In step S235, the attribute data reconstruction unit 433 reconstructs the attribute data for the geometry data of the processing target patch reconstructed as described above.

In step S236, the attribute data reconstruction unit 433 determines whether or not all the patches have been processed. If it is determined that there exists an unprocessed patch (a patch from which a point cloud has not been reconstructed) in the processing target video frame, the process returns to step S231, and the processes after that are repeated.

That is, the respective processes in steps S231 to S236 are performed for each patch. If it is determined in step S236 that all the patches have been processed, on the other hand, the point cloud reconstruction process comes to an end, and the process returns to FIG. 22.

By performing the point cloud reconstruction process as described above, the 3D reconstruction unit 417 can round the coordinates of the points and turn the coordinates into integers, so as to reduce movement of the points in a horizontal direction with respect to the projection plane. Thus, the decoding device 400 can reduce degradation of the subjective quality of the point cloud.

<Flow 2 in the Point Cloud Reconstruction Process>

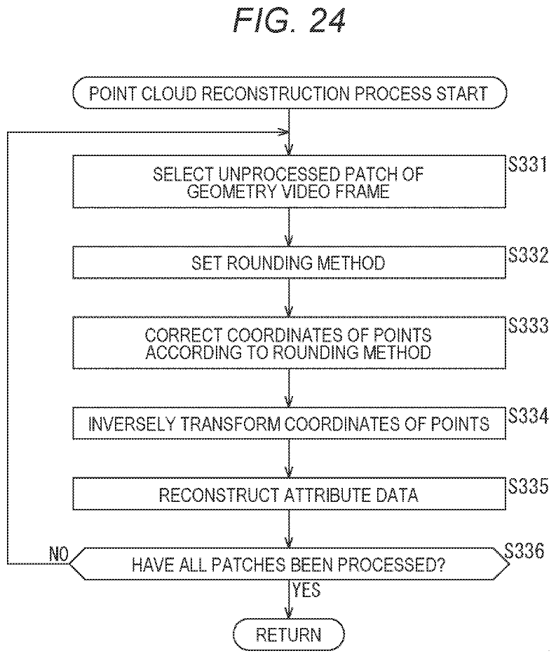

Further, a case where the coordinates of points are rounded in the projection coordinate system in step S207 in FIG. 22 (a case where “Method 2 (Method 2-1 to Method 2-3)” shown in FIG. 6 is adopted) is now described. In this case, the point cloud reconstruction process is performed in a flow like a flowchart shown in FIG. 24, for example.

In this case, when the point cloud reconstruction process is started, the rounding method setting unit 431 of the 3D reconstruction unit 417 selects an unprocessed patch of the geometry data as the processing target in step 3331.

In step S332, the rounding method setting unit 431 sets the method for rounding the coordinates of the points, regardless of the orientation of the projection plane. For example, the rounding method setting unit 431 performs setting such as scale transform. Note that, here, the rounding method setting unit 431 may select the direction in which the points are moved by the rounding of the coordinates, as described above in <1. Point Cloud Reconstruction>.

In step S333, the geometry data reconstruction unit 432 performs scale transform on the projection coordinate system as appropriate, rounds the coordinates of each point of the processing target patch in the projection coordinate system, and turns the coordinates into integers, using the method set in step S332. That is, the geometry data reconstruction unit 432 rounds the coordinates of the coordinate axes of the points in a direction perpendicular to the projection plane, and turns the coordinate into integers (corrects the coordinates).

In step S334, the geometry data reconstruction unit 432 inversely transforms the coordinates of each point of the processing target patch. That is, the geometry data reconstruction unit 432 transforms the coordinates of each point in the projection coordinate system into the coordinates of the basic coordinate system.

In step S335, the attribute data reconstruction unit 433 reconstructs the attribute data for the geometry data of the processing target patch reconstructed as described above.

In step S336, the attribute data reconstruction unit 433 determines whether or not all the patches have been processed. If it is determined that there exists an unprocessed patch (a patch from which a point cloud has not been reconstructed) in the processing target video frame, the process returns to step S331, and the processes after that are repeated.

That is, the respective processes in steps S331 to S336 are performed for each patch. If it is determined in step S336 that all the patches have been processed, on the other hand, the point cloud reconstruction process comes to an end, and the process returns to FIG. 22.

By performing the point cloud reconstruction process as described above, the 3D reconstruction unit 417 can round the coordinates of the points and turn the coordinates into integers, so as to reduce movement of the points in a horizontal direction with respect to the projection plane. Thus, the decoding device 400 can reduce degradation of the subjective quality of the point cloud.

### 3. Notes

<Computer>

The series of processes described above can be performed by hardware or can be performed by software. When the series of processes are to be performed by software, the program that forms the software is installed into a computer. Here, the computer may be a computer incorporated into special-purpose hardware, or may be a general-purpose personal computer or the like that can execute various kinds of functions when various kinds of programs are installed thereinto, for example.

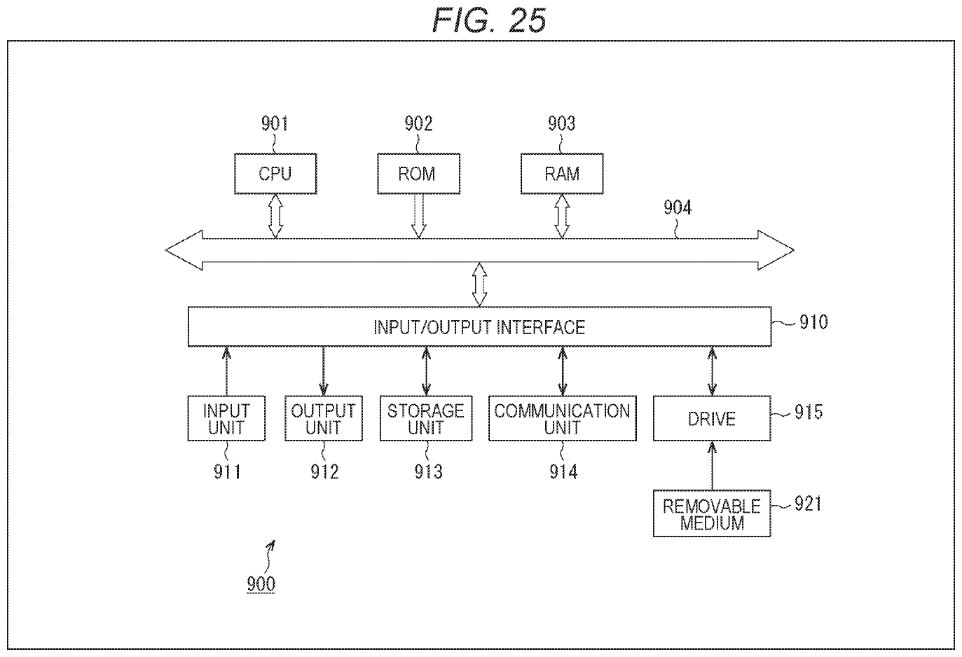

FIG. 25 is a block diagram showing an example configuration of the hardware of a computer that performs the above described series of processes in accordance with a program.

In a computer 900 shown in FIG. 25, a central processing unit (CPU) 901, a read only memory (ROM) 902, and a random access memory (RAM) 903 are connected to one another by a bus 904.

An input/output interface 910 is also connected to the bus 904. An input unit 911, an output unit 912, a storage unit 913, a communication unit 914, and a drive 915 are connected to the input/output interface 910.

The input unit 911 is formed with a keyboard, a mouse, a microphone, a touch panel, an input terminal, and the like, for example. The output unit 912 is formed with a display, a speaker, an output terminal, and the like, for example. The storage unit 913 is formed with a hard disk, a RAM disk, a nonvolatile memory, and the like, for example. The communication unit 914 is formed with a network interface, for example. The drive 915 drives a removable medium 921 such as a magnetic disk, an optical disk, a magnetooptical disk, or a semiconductor memory.

In the computer having the above described configuration, the CPU 901 loads a program stored in the storage unit 913 into the RAM 903 via the input/output interface 910 and the bus 904, for example, and executes the program, so that the above described series of processes is performed. The RAM 903 also stores data necessary for the CPU 901 to perform various processes and the like as necessary.

The program to be executed by the computer can be recorded on the removable medium 921 as a packaged medium or the like to be used, for example. In that case, the program can be installed into the storage unit 913 via the input/output interface 910 when the removable medium 921 is mounted on the drive 915.

Alternatively, this program can be provided via a wired or wireless transmission medium such as a local area network, the Internet, or digital satellite broadcasting. In that case, the program can be received by the communication unit 914, and be installed into the storage unit 913.

Also, this program can be installed beforehand into the ROM 902 or the storage unit 913.

<Targets to which the Present Technology is Applied>

Although cases where the present technology is applied to encoding and decoding of point cloud data have been described so far, the present technology is not limited to those examples, but can be applied to encoding and decoding of 3D data of any standard. That is, various processes such as encoding and decoding processes, and any specifications of various kinds of data such as 3D data and metadata can be adopted, as long as the present technology described above is not contradicted. Also, some of the processes and specifications described above may be omitted, as long as the present technology is not contradicted.

Further, in the above description, the encoding device 300 and the decoding device 400 have been described as example applications of the present technology, but the present technology can be applied to any desired configuration.

For example, the present technology can be applied to various electronic apparatuses, such as transmitters and receivers (television receivers or portable telephone devices, for example) in satellite broadcasting, cable broadcasting such as cable TV, distribution via the Internet, distribution to terminals via cellular communication, or the like, and apparatuses (hard disk recorders or cameras, for example) that record images on media such as optical disks, magnetic disks, and flash memory, and reproduce images from these storage media, for example.

Further, the present technology can also be embodied as a component of an apparatus, such as a processor (a video processor, for example) serving as a system LSI (Large Scale Integration) or the like, a module (a video module, for example) using a plurality of processors or the like, a unit (a video unit, for example) using a plurality of modules or the like, or a set (a video set, for example) having other functions added to units.

Further, for example, the present technology can also be applied to a network system formed with a plurality of devices. For example, the present technology may be embodied as cloud computing that is shared and jointly processed by a plurality of devices via a network. For example, the present technology may be embodied in a cloud service that provides services related to images (video images) to any kinds of terminals such as computers, audio visual (AV) devices, portable information processing terminals, and IoT (Internet of Things) devices.

Note that, in the present specification, a system means an assembly of a plurality of components (devices, modules (parts), and the like), and not all the components need to be provided in the same housing. In view of this, a plurality of devices that are housed in different housings and are connected to one another via a network form a system, and one device having a plurality of modules housed in one housing is also a system.

<Fields and Usage to which the Present Technology can be Applied>

A system, an apparatus, a processing unit, and the like to which the present technology is applied can be used in any appropriate field such as transportation, medical care, crime prevention, agriculture, the livestock industry, mining, beauty care, factories, household appliances, meteorology, or nature observation, for example. The present technology can also be used for any appropriate purpose.

<Other Aspects>

Note that, in this specification, a “flag” is information for identifying a plurality of states, and includes not only information to be used for identifying two states of true (1) or false (0), but also information for identifying three or more states. Therefore, the values this “flag” can have may be the two values of “1” and “0”, for example, or three or more values. That is, this “flag” may be formed with any number of bits, and may be formed with one bit or a plurality of bits. Further, as for identification information (including a flag), not only the identification information but also difference information about the identification information with respect to reference information may be included in a bitstream. Therefore, in this specification, a “flag” and “identification information” include not only the information but also difference information with respect to the reference information.

Further, various kinds of information (such as metadata) regarding encoded data (a bitstream) may be transmitted or recorded in any mode that is associated with the encoded data. Here, the term “to associate” means to enable use of other data (or a link to other data) while data is processed, for example. That is, pieces of data associated with each other may be integrated as one piece of data, or may be regarded as separate pieces of data. For example, information associated with encoded data (an image) may be transmitted through a transmission path different from that for the encoded data (image). Further, information associated with encoded data (an image) may be recorded in a recording medium different from that for the encoded data (image) (or in a different recording area of the same recording medium), for example. Note that this “association” may apply to part of the data, instead of the entire data. For example, an image and the information corresponding to the image may be associated with each other for any appropriate unit, such as for a plurality of frames, each frame, or some portion in each frame.

Note that, in this specification, the terms “to combine”, “to multiplex”, “to add”, “to integrate”, “to include”, “to store”, “to contain”, “to incorporate, “to insert”, and the like mean combining a plurality of objects into one, such as combining encoded data and metadata into one piece of data, for example, and mean a method of the above described “association”.

Further, embodiments of the present technology are not limited to the above described embodiments, and various modifications may be made to them without departing from the scope of the present technology.

For example, any configuration described above as one device (or one processing unit) may be divided into a plurality of devices (or processing units). Conversely, any configuration described above as a plurality of devices (or processing units) may be combined into one device (or one processing unit). Furthermore, it is of course possible to add a component other than those described above to the configuration of each device (or each processing unit). Further, some components of a device (or processing unit) may be incorporated into the configuration of another device (or processing unit) as long as the configuration and the functions of the entire system remain substantially the same.

Also, the program described above may be executed in any device, for example. In that case, the device is only required to have necessary functions (function blocks and the like) so that necessary information can be obtained.

Also, one device may carry out each step in one flowchart, or a plurality of devices may carry out each step, for example. Further, when one step includes a plurality of processes, the plurality of processes may be performed by one device or may be performed by a plurality of devices. In other words, a plurality of processes included in one step can be performed as processes in a plurality of steps. Conversely, processes described as a plurality of steps can be collectively performed as one step.

Also, a program to be executed by a computer may be a program for performing the processes in the steps according to the program in chronological order in accordance with the sequence described in this specification, or may be a program for performing processes in parallel or performing a process when necessary, such as when there is a call, for example. That is, as long as there are no contradictions, the processes in the respective steps may be performed in a different order from the above described order. Further, the processes in the steps according to this program may be executed in parallel with the processes according to another program, or may be executed in combination with the processes according to another program.

Also, each of the plurality of techniques according to the present technology can be independently implemented, as long as there are no contradictions, for example. It is of course also possible to implement a combination of some of the plurality of techniques according to the present technology. For example, part or all of the present technology described in one of the embodiments can be implemented in combination with part or all of the present technology described in another one of the embodiments. Further, part or all of the present technology described above can be implemented in combination with some other technology not described above.

Note that the present technology can also be embodied in the configurations described below.

(1) An image processing apparatus including:

a decoding unit that decodes encoded data of a frame image in which a projection image of a point cloud representing a three-dimensional object as a set of points on a two-dimensional plane is placed;

an unpacking unit that unpacks the frame image obtained by the decoding unit decoding the encoded data, and extracts the projection image; and

a reconstruction unit that reconstructs the point cloud by arranging the respective points included in the projection image extracted by the unpacking unit in a three-dimensional space,

in which, when the coordinates of the point are not integer values in a basic coordinate system that is a predetermined coordinate system of the three-dimensional space, the reconstruction unit moves the point in a direction perpendicular to the two-dimensional plane so as to turn the coordinates of the point into integer values.

(2) The image processing apparatus according to (1), in which

the reconstruction unit moves the point by updating the coordinates of the point in the basic coordinate system.

(3) The image processing apparatus according to (2), in which

the reconstruction unit moves the point by rounding up or down a decimal value of each coordinate of the point in the basic coordinate system.

(4) The image processing apparatus according to (3), in which

the reconstruction unit determines to round up or to round down the decimal value of each coordinate of the point in the basic coordinate system, in accordance with the orientation of the two-dimensional plane.

(5) The image processing apparatus according to any one of (2) to (4), in which

the reconstruction unit moves the point in a direction toward the two-dimensional plane, the direction being a direction perpendicular to the two-dimensional plane.

(6) The image processing apparatus according to any one of (2) to (4), in which

the reconstruction unit moves the point in a direction away from the two-dimensional plane, the direction being a direction perpendicular to the two-dimensional plane.

(7) The image processing apparatus according to any one of (2) to (6), in which

the reconstruction unit sets a direction of movement of the point for each frame.

(8) The image processing apparatus according to (1), in which

the reconstruction unit moves the point by updating a coordinate of the point in a projection coordinate system that is a coordinate system having a coordinate axis perpendicular to the two-dimensional plane.

(9) The image processing apparatus according to (8), in which

the reconstruction unit moves the point by performing scale transform on the projection coordinate system in accordance with the basic coordinate system, and turning a coordinate of the point on a coordinate axis perpendicular to the two-dimensional plane in the projection coordinate system into an integer in the projection coordinate system after the scale transform.

(10) The image processing apparatus according to (9), in which

the reconstruction unit moves the point by rounding down a decimal value of a coordinate of the point on the coordinate axis perpendicular to the two-dimensional plane in the projection coordinate system.

(11) The image processing apparatus according to (9), in which

the reconstruction unit moves the point by rounding up a decimal value of a coordinate of the point on the coordinate axis perpendicular to the two-dimensional plane in the projection coordinate system.

(12) The image processing apparatus according to (9), in which

the reconstruction unit selects movement caused in the point by rounding up a decimal value of the coordinate of the coordinate axis perpendicular to the two-dimensional plane of the projection coordinate system of the point, or movement caused in the point by rounding down the decimal value of the coordinate of the coordinate axis perpendicular to the two-dimensional plane of the projection coordinate system of the point, whichever has the shorter moving distance of the point.

(13) The image processing apparatus according to (12), in which

the reconstruction unit sets a direction of movement of the point for each frame.

(14) The image processing apparatus according to any one of (1) to (13), in which

the reconstruction unit moves the point in a direction perpendicular to the two-dimensional plane, in accordance with accuracy of an occupancy map.

(15) The image processing apparatus according to (14), in which,

when the accuracy of the occupancy map is 1, the reconstruction unit moves the point in a direction perpendicular to the two-dimensional plane.

(16) The image processing apparatus according to any one of (1) to (15), in which

the reconstruction unit reconstructs the point cloud by placing each point included in the projection image extracted by the unpacking unit at a plurality of locations in a three-dimensional space.

(17) The image processing apparatus according to (16), in which

the reconstruction unit moves one of the points in both a direction toward the two-dimensional plane and a direction away from the two-dimensional plane, each direction being a direction perpendicular to the two-dimensional plane, and reconstructs the point cloud including the respective points after the movement.

(18) The image processing apparatus according to (16), in which

the reconstruction unit reconstructs the point cloud including the point after being moved in a direction perpendicular to the two-dimensional plane and the point before being moved.

(19) The image processing apparatus according to any one of (1) to (18), in which

the reconstruction unit reconstructs attribute information about the point cloud.

(20) An image processing method including:

decoding encoded data of a frame image in which a projection image of a point cloud representing a three-dimensional object as a set of points on a two-dimensional plane is placed;

unpacking the frame image obtained by decoding the encoded data, and extracting the projection image; and

reconstructing the point cloud by arranging the respective points included in the extracted projection image in a three-dimensional space, and, when the coordinates of the point are not integer values in a basic coordinate system that is a predetermined coordinate system of the three-dimensional space, moving the point in a direction perpendicular to the two-dimensional plane so as to turn the coordinates of the point into integer values.

### REFERENCE SIGNS LIST

400 Decoding device
411 Demultiplexer
412 Auxiliary patch information decoding unit
413 and 414 Video decoding unit
415 OMap decoding unit
416 Unpacking unit
417 3D reconstruction unit
431 Rounding method setting unit
432 Geometry data reconstruction unit
433 Attribute data reconstruction unit

1. An image processing apparatus comprising:
a decoding unit that decodes encoded data of a frame image in which a projection image of a point cloud representing a three-dimensional object as a set of points on a two-dimensional plane is placed;
an unpacking unit that unpacks the frame image obtained by the decoding unit decoding the encoded data, and extracts the projection image; and
a reconstruction unit that reconstructs the point cloud by arranging the respective points included in the projection image extracted by the unpacking unit in a three-dimensional space,
wherein, when a coordinate of the point is not an integer value in a basic coordinate system that is a predetermined coordinate system of the three-dimensional space, the reconstruction unit moves the point in a direction perpendicular to the two-dimensional plane so as to turn the coordinate of the point into an integer value.

2. The image processing apparatus according to claim 1, wherein
the reconstruction unit moves the point by updating coordinates of the point in the basic coordinate system.

3. The image processing apparatus according to claim 2, wherein
the reconstruction unit moves the point by rounding up or down a decimal value of each coordinate of the point in the basic coordinate system.

4. The image processing apparatus according to claim 3, wherein
the reconstruction unit determines to round up or to round down a decimal value of each coordinate of the point in the basic coordinate system, in accordance with an orientation of the two-dimensional plane.

5. The image processing apparatus according to claim 2, wherein
the reconstruction unit moves the point in a direction toward the two-dimensional plane, the direction being a direction perpendicular to the two-dimensional plane.

6. The image processing apparatus according to claim 2, wherein
the reconstruction unit moves the point in a direction away from the two-dimensional plane, the direction being a direction perpendicular to the two-dimensional plane.

7. The image processing apparatus according to claim 2, wherein
the reconstruction unit sets a direction of movement of the point for each frame.

8. The image processing apparatus according to claim 1, wherein
the reconstruction unit moves the point by updating a coordinate of the point in a projection coordinate system that is a coordinate system having a coordinate axis perpendicular to the two-dimensional plane.

9. The image processing apparatus according to claim 8, wherein
the reconstruction unit moves the point by performing scale transform on the projection coordinate system in accordance with the basic coordinate system, and turning a coordinate of the point on the coordinate axis perpendicular to the two-dimensional plane in the projection coordinate system into an integer in the projection coordinate system after the scale transform.

10. The image processing apparatus according to claim 9, wherein
the reconstruction unit moves the point by rounding down a decimal value of a coordinate of the point on the coordinate axis perpendicular to the two-dimensional plane in the projection coordinate system.

11. The image processing apparatus according to claim 9, wherein
the reconstruction unit moves the point by rounding up a decimal value of a coordinate of the point on the coordinate axis perpendicular to the two-dimensional plane in the projection coordinate system.

12. The image processing apparatus according to claim 9, wherein
the reconstruction unit selects movement caused in the point by rounding up a decimal value of the coordinate of the point on the coordinate axis perpendicular to the two-dimensional plane in the projection coordinate system, or movement caused in the point by rounding down the decimal value of the coordinate of the point on the coordinate axis perpendicular to the two-dimensional plane in the projection coordinate system, whichever has the shorter moving distance of the point.

13. The image processing apparatus according to claim 12, wherein
the reconstruction unit sets a direction of movement of the point for each frame.

14. The image processing apparatus according to claim 1, wherein
the reconstruction unit moves the point in a direction perpendicular to the two-dimensional plane, in accordance with accuracy of an occupancy map.

15. The image processing apparatus according to claim 14, wherein,
when the accuracy of the occupancy map is 1, the reconstruction unit moves the point in a direction perpendicular to the two-dimensional plane.

16. The image processing apparatus according to claim 1, wherein
the reconstruction unit reconstructs the point cloud by placing each point included in the projection image extracted by the unpacking unit at a plurality of locations in a three-dimensional space.

17. The image processing apparatus according to claim 16, wherein
the reconstruction unit moves one of the points in both a direction toward the two-dimensional plane and a direction away from the two-dimensional plane, each direction being a direction perpendicular to the two-dimensional plane, and reconstructs the point cloud including the respective points after the movement.

18. The image processing apparatus according to claim 16, wherein
the reconstruction unit reconstructs the point cloud including the point after being moved in a direction perpendicular to the two-dimensional plane and the point before being moved.

19. The image processing apparatus according to claim 1, wherein
the reconstruction unit reconstructs attribute information about the point cloud.

20. An image processing method comprising:
decoding encoded data of a frame image in which a projection image of a point cloud representing a three-dimensional object as a set of points on a two-dimensional plane is placed;
unpacking the frame image obtained by decoding the encoded data, and extracting the projection image; and
reconstructing the point cloud by arranging the respective points included in the extracted projection image in a three-dimensional space, and, when a coordinate of the point is not an integer value in a basic coordinate system that is a predetermined coordinate system of the three-dimensional space, moving the point in a direction perpendicular to the two-dimensional plane so as to turn the coordinate of the point into an integer value.
